(19) United States
(12) Patent Application Publication
(10) Pub. No.: US 2025/0281831 A1
(43) Pub. Date: Sep. 11, 2025

(54) NON-TRANSITORY COMPUTER READABLE MEDIUM STORING PROGRAM, AND GAMING DEVICE

(71) Applicant: BANDAI CO., LTD., Tokyo (JP)

(72) Inventors: Satoshi TAKEDA, Tokyo (JP); Masahiko SAITO, Tokyo (JP); Kensuke MITA, Tokyo (JP)

(21) Appl. No.: 19/067,892

(22) Filed: Mar. 1, 2025

(30) Foreign Application Priority Data
Mar. 8, 2024 (JP) 2024-036361

(51) Int. Cl. A63F 13/52

(52) U.S. Cl. CPC A63F 13/52

(57) ABSTRACT

There is provided a non-transitory computer readable medium storing a program causing a computer to function as: an execution unit configured to execute a fighting game using a game element; a play field presentation unit configured to present a play field including a plurality of areas; and a game element presentation unit configured to present character information of a game element of a player positioned in a first area among the plurality of areas so that the character information is visually unrecognizable to an opponent player, and to present character information of a game element of the player positioned in a second area so that the character information is visually recognizable to the opponent player.

### CROSS-REFERENCES TO RELATED APPLICATIONS

This application claims priority to Japanese Patent Application No. 2024-036361 filed in the Japan Patent Office on Mar. 8, 2024, the entire contents of which are incorporated herein by reference.

### BACKGROUND OF THE INVENTION

### 1. Field of the Invention

The present invention relates to a non-transitory computer readable medium storing a program, and a gaming device.

### 2. Description of the Related Art

In recent years, game systems have been widespread which provide games to the terminals of players through a communication network. The server of the game systems provides various game elements usable for games (for example, Japanese Unexamined Patent Application Publication No. 2015-047516).

### SUMMARY OF THE INVENTION

In the game system as described above, it is an important task to devise the types of game elements provided to players and the method for presenting the game elements to continue the interest of the players to the games. As a result, games with improved enjoyment for players are provided.

Thus, it is an object of the present invention to provide a non-transitory computer readable medium storing a program and a gaming device that can provide games with improved enjoyment for players.

An aspect of the present invention provides a non-transitory computer readable medium storing a program causing a computer to function as: an execution unit configured to execute a fighting game using a game element; a play field presentation unit configured to present a play field including a plurality of areas; and a game element presentation unit configured to present character information of a game element of a player positioned in a first area among the plurality of areas so that the character information is visually unrecognizable to an opponent player, and to present character information of a game element of the player positioned in a second area so that the character information is visually recognizable to the opponent player.

An aspect of the present invention provides a gaming device including: an execution unit configured to execute a fighting game using a game element; a play field presentation unit configured to present a play field including a plurality of areas; and a game element presentation unit configured to present character information of a game element of a player positioned in a first area among the plurality of areas so that the character information is visually unrecognizable to an opponent player, and to present character information of a game element of the player positioned in a second area so that the character information is visually recognizable to the opponent player.

### BRIEF DESCRIPTION OF THE DRAWINGS

FIG. 1 is a view illustrating an entire configuration example of a game system in the present embodiment;

FIG. 2 is a view illustrating a device configuration example of a laptop PC which is an example of a player terminal;

FIG. 3 is a view for explaining an example of the front surface of a leader card;

FIG. 4 is a view for explaining an example of the back surface of the leader card;

FIG. 5 is a view for explaining an example of the front surface of a battle card;

FIG. 6 is a view for explaining an example of the back surface of the battle card;

FIG. 7 is a view for explaining an example of the front surface of an extra card;

FIG. 8 is a block diagram illustrating a functional configuration example of the player terminal;

FIG. 9 is a table illustrating an example of a player information database;

FIG. 10 is a table illustrating an example of a game element information database;

FIG. 11 is a view illustrating an example of a home screen;

FIG. 12 is a view illustrating an example of a store screen;

FIG. 13 is a view illustrating an example of a store screen;

FIG. 14 is a view illustrating an example of display of currently tradable game elements and currently untradable game elements on the store screen;

FIG. 15 is a view illustrating an example of display of breakdown between paid-for and free of charge in-game currency units currently possessed;

FIG. 16 is a view illustrating an example of an in-game currency providing screen;

FIG. 17 is a view illustrating an example of when the number of times of provision (grant) of a first paid-for currency pack has reached an upper limit, resulting in a sold-out state;

FIG. 18 is a view illustrating an example of a screen to be displayed when the in-game currency for the price of a game element is insufficient

FIG. 19 is a block diagram illustrating a functional configuration example of a game server;

FIG. 20 is a table illustrating an example of a user information management database;

FIG. 21 is a table illustrating an example of a game element management database;

FIG. 22 is a table illustrating an example of a store management database;

FIG. 23 is a sequence diagram for explaining the operation of the player terminal and the game server;

FIG. 24 shows tables for explaining determination as to whether each game element is providable (grantable) or unprovidable (ungrantable);

FIG. 25 is a view illustrating an example of a notification made when the total charge exceeds a predetermined amount;

FIG. 26 shows views for explaining modification of the embodiment;

FIGS. 27A to 27F show views for explaining an opening direction example;

FIG. 28 is a table illustrating an example of a pack information database;

FIG. 29 is a sequence diagram for explaining the operation of the player terminal and the game server;

FIG. 30 is an operation flowchart for a pack opening direction process;

FIGS. 31A to 31F show views for explaining an opening direction example;

FIGS. 32A to 32D show views for explaining an opening direction example;

FIG. 33 is a view illustrating an example of a deck formation screen;

FIG. 34 is a view for explaining a first area and a second area;

FIG. 35 is a view for explaining a function of enlarging game cards in the second area;

FIG. 36 is an example of popup display when a formed deck satisfies (6) deck non-conforming criterion;

FIG. 37 is a view illustrating an example of display when a formed deck satisfies a deck non-conforming condition;

FIG. 38 is an example of a deck information database D20;

FIG. 39 is an example of a registration deck list screen;

FIG. 40 is a view illustrating an example of a play field presented by a play field presentation unit;

FIG. 41 is a view illustrating an example of presentation of game cards by a game card presentation unit;

FIG. 42 is an example of a viewing screen presented on a play field;

FIG. 43 shows views for explaining the viewing screen;

FIG. 44 is a view for explaining the viewing screen;

FIG. 45 shows views for explaining the viewing screen;

FIG. 46 is a view illustrating an example when a hand of cards is enlarged;

FIG. 47 shows views for explaining switching between reduced display and enlarged display;

FIG. 48 is a view for explaining a state of selection of game cards;

FIG. 49 is a view for explaining a state of selection of game cards; and

FIG. 50 is a view illustrating an example of display of selectable actions.

### DESCRIPTION OF THE PREFERRED EMBODIMENTS

### Entire Configuration

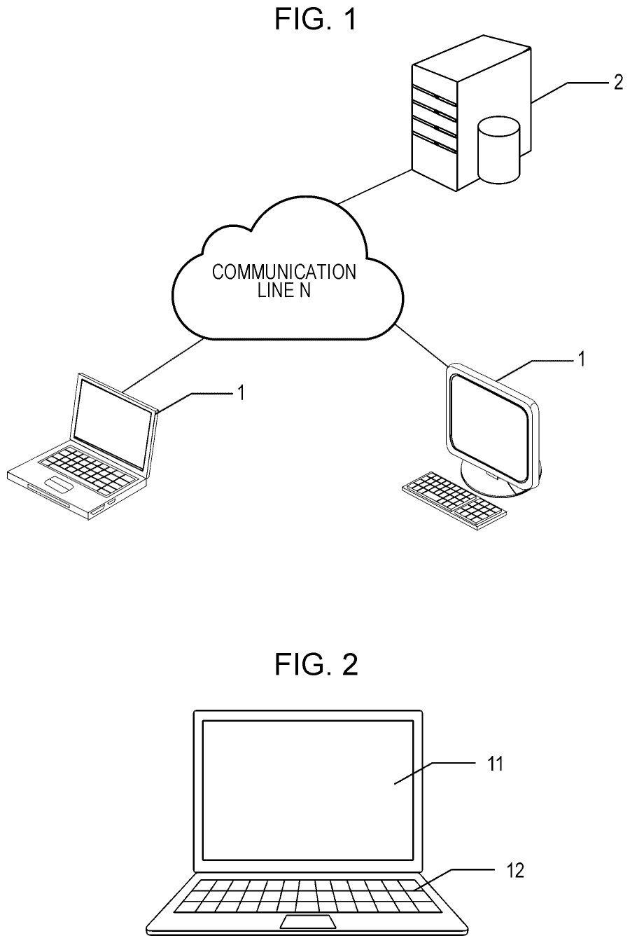

FIG. 1 is a view illustrating an entire configuration example of a game system in the present embodiment. As illustrated in FIG. 1, the game system includes a player terminal 1, and a game server 2 which are prepared for players A, B of a game. The player terminal 1 and the game server 2 are connectable to a communication line N, and can communicate with each other.

The communication line N indicates a communications path that enables data communication. For example, in addition to a dedicated line (dedicated cable) for direct connection and LAN based on the Ethernet (registered trademark), the communication line N includes a communication network such as a telecommunication network, a cable network, and the Internet, and the communication method may be wired or wireless.

The player terminal 1 is a computer that can execute a game program, and can perform data communication with the game server 2 by connecting to the communication line N through a wireless communication base station. The player terminal 1 is e.g., a personal computer, a smartphone, a mobile phone, a mobile gaming device, a stationary game console, a commercial game console, a tablet computer, and a controller for a stationary game console. Basically, multiple player terminals 1 are provided, and are operated by respective players.

The game server 2 is a server system that includes a single or multiple server devices and storage devices. The game server 2 provides various services for administering the games of the present embodiment, and is capable of managing data necessary for the administration of the games, and of distributing game programs and data necessary for execution of the games at the player terminals 1.

FIG. 2 is a view illustrating a device configuration example of a laptop PC which is an example of the player terminal 1. As illustrated in FIG. 2, the player terminal 1 includes a display 11, and a keyboard 12 which is an operation unit. The player terminal 1 is provided with a control board, a built-in battery, a power button, a sound volume adjustment button, a speaker, and the like which are not illustrated.

The control board is equipped with various microprocessors, ASIC such as a CPU, a GPU, and a DSP; various IC memories such as a VRAM, a RAM, and a ROM; and a wireless communication module to wirelessly communicate with a mobile phone base station. In addition, the control board is equipped with so-called an I/F circuit (interface circuit) such as a driver circuit of a touch operation panel 12. The elements mounted on the control board are electrically coupled to each other through a bus circuit so that reading and writing of data and transmission and reception of signals are made possible.

Multiple types of game elements appear in the game in the present embodiment. Each game element will be described below.

### First Type Game Element

A first type game element is an article into which a character is transformed, and is represented as an image. The image includes a still image and a video. The article may be an intangible object or a tangible object. The article is e.g., a virtual game card displayed on a computer, or a tangible game card. Note that the article is not limited to the card as long as the article is configured to identify the game element associated with the article. The article may be a modeled object such as a figure having the appearance of a game element. In the following, a case will be described as an example where the first type game element is a virtual game card into which a character is transformed.

In the game in the present embodiment, game card as the first type game element has multiple types. The information written on the front surface of a game card varies with the type of the game card. Although any number of types of game card may be provided, in the following, a description will be given using an example of three types of game cards: a leader card 21 (a first type first game element), a battle card 22 (a first type second game element), and an extra card 23 (a first type third game element). The common point among all types of game cards is that a character image in a work is associated with each game card. The character image is the image of a character that appears in a work, and in the present embodiment, the image of a scene including the character that appears in a work is also described as a character image. Multiple game cards with the same character and different picture patterns are provided, and treated as different game cards.

A player constructs a deck in advance using obtained game cards, and plays a game. When a deck is constructed, the total number of cards in the deck and the number of various types of cards are predetermined. In the present embodiment, a description will be given using an example of a deck with the total number of 50 cards including one leader card 21; however, the deck may have any number of cards as long as the number of cards is predetermined.

Each game card has a regular position, in which the content written on the game card as seen from a player can be determined as it is. Multiple position states of the game card are provided. In the following description, a state in which the game card is in regular position is called an active state, and a sideways state in which the game card is rotated 90 degrees is called a rest state. In a predetermined area, a reverse position state in which the game card is rotated 180 degrees is called an active state. Note that game card in a predetermined direction may be determined as an active state in advance, and a state when the direction of the game card is changed from the predetermined direction may be determined as a rest state. During a game, these states of the game card may be used as appropriate.

### Leader Card 21

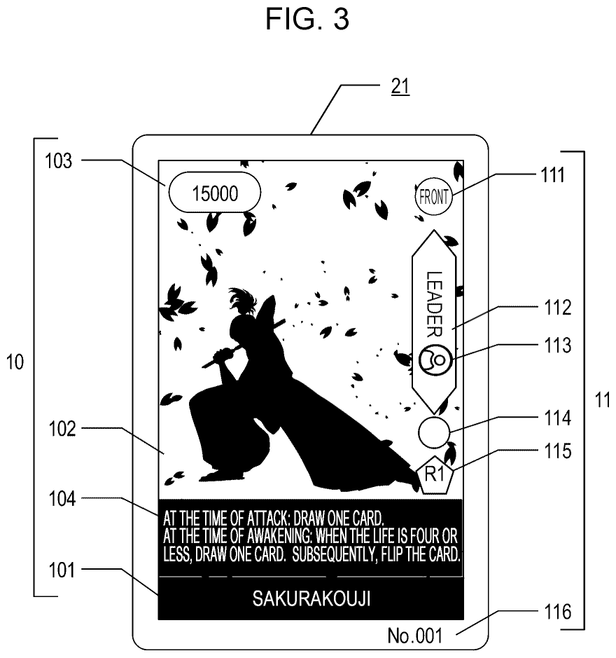

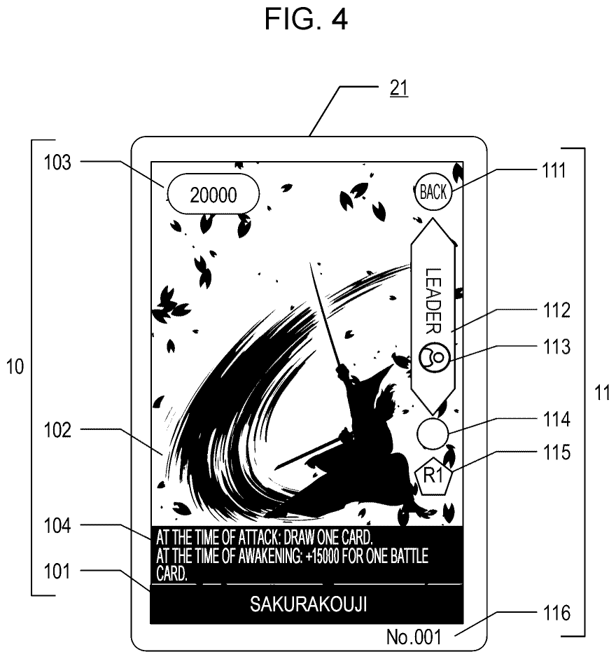

The leader card 21 (the first type first game element) will be described. FIGS. 3 and 4 are views illustrating an example of the leader card 21. FIG. 3 is a view for explaining an example of the front surface of the leader card 21. FIG. 4 is a view for explaining an example of the back surface of the leader card 21. One leader card 21 is included in each deck. The leader card 21 battles against the leader card 21 or the battle card 22 of the opponent player.

Character information 10 and card information 11 are respectively written on the front surface and the back surface of the leader card 21. When a game starts, the leader card 21 is placed so that the front surface is seen; however, when a predetermined condition is satisfied, the leader card 21 is placed so that the back surface is seen.

The leader card 21 includes the character information 10 and the card information 11, and the character information 10 includes a character name 101, a character image 102, capability information 103, and effect information 104.

The character name 101 is the name of a character associated with the card. In the example illustrated in FIGS. 3 and 4, “Sakurakouji” is written.

The character image 102 is the image of a character associated with the card.

The capability information 103 is a parameter for the ability of a character associated with the game card. In the present embodiment, a description will be given using a case where the power value of a character is written as the capability information. Victory is achieved when the power value is greater than the power value of the battle card 22 of the opponent player. In the example of FIG. 3, the power value “15000” is written, and in the example of FIG. 4, the power value “20000” is written.

The effect information 104 describes skill information related to the effect exercised at the time of attack and awakening information related to the condition and effect for turning the card front to back. In the example of FIG. 3, “At the time of attack: draw one card.” is written as the skill information, and “When the life is four or less, draw one card. Subsequently, flip the card.” is written as the awakening information.

Note that the capability information 103 and the effect information 104 may be included in the character information 10; however, a description will be given using an example in which the capability information 103 and the effect information 104 are not included in the character information.

The card information 11 includes front/back information 111, a card type name 112, a card type symbol 113, color information 114, a rarity level 115, and card identification information 116.

The front/back information 111 is information that clearly specifies the front or back of the leader card 21, and may be any of a character string, illustration, or a symbol mark as long as the information identifies the front or back. In the example illustrated in FIG. 3, the character “front” indicates the front surface as the front/back information, and in the example illustrated in FIG. 4, the character string “back” indicates the back surface as the front/back information. Note that the front/back information may be provided at least on the back surface. This is because for the game cards of a card game, the appearance of each card itself is regarded as important, thus extra information should not be written on the front surface.

The card type name 112 is information indicating the type of a card. The card type name 112 is recorded with information on one of the leader card, the battle card, and the extra card, and in the example of the leader card 21 illustrated FIGS. 3 and 4, the card type name 112 is recorded with “leader”.

The card type symbol 113 is recorded with one of the symbols that distinguish between the leader card 21, the battle card 22, and the extra card 23. The leader card 21 is recorded with a leader symbol indicating the leader card. The leader symbol (the first symbol) may be a symbol that can recall the role of the leader card 21 so as to visually identify the leader card.

The color information 114 indicates information on the color of the card. A player refers to the color information 114 of the leader card 21, and constructs a deck using the battle cards 22 and the extra cards 23 with the same color information.

The rarity level 115 indicates the rarity level of the game card. Any display method may be adopted as long as the rarity level is set in advance. In the present embodiment, a description will be given using a case where the rarity is divided into five scales. The example illustrated in FIGS. 3 and 4 exemplifies a case where the rarity level is one.

The card identification information 116 is recorded with identification information that uniquely identifies the game card. In the example of FIGS. 3 and 4, “001” is written as the card identification information 116.

The leader card 21 is different from the other game cards, and the card type symbol 113 (the leader symbol), and the capability information 103 or the effect information 104 are written on the front and back of the card. The capability information 103 or the effect information 104 are different between the front and the back. Thus, evolution or awakening of one character can be expressed by one card, and it is possible to identify the leader card by the display on the front and back.

### Battle Card 22

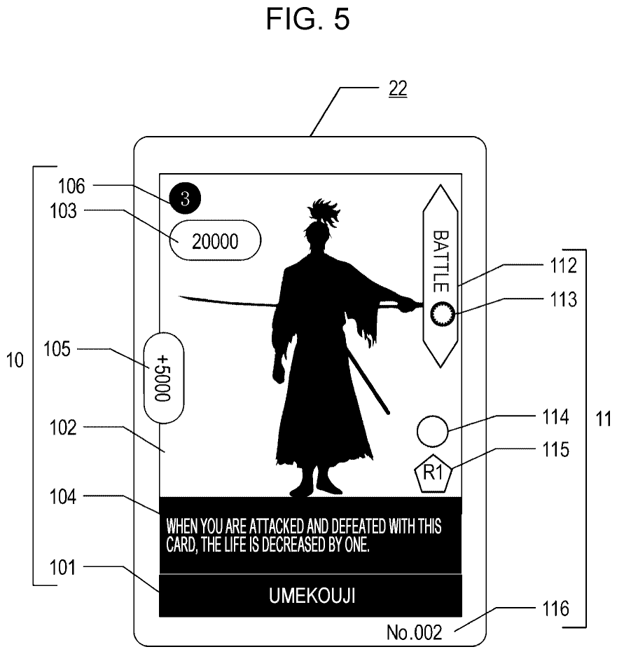

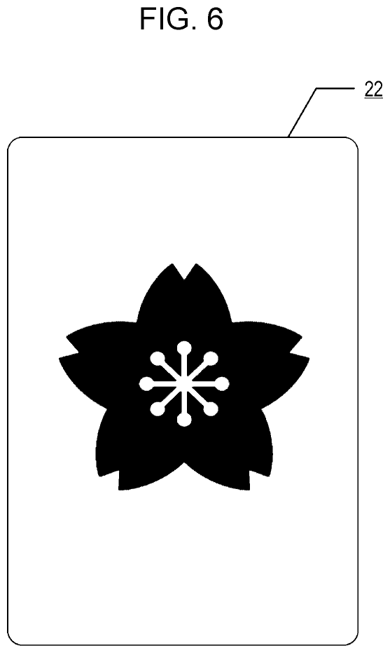

The battle card 22 (the first type second game element) will be described. FIG. 5 is a view for explaining an example of the front surface of the battle card 22. FIG. 6 is a view for explaining an example of the back surface of the battle card 22. As illustrated in FIG. 5, in the battle card 22, the image of an associated character is shown only on the front surface. All the back surfaces of the battle cards 22 are the same. The battle card 22 is a card for attacking the leader card 21 or the battle card 22 of an opponent player.

The battle card 22 includes the character information 10 and the card information 11.

As in the leader card 21, the character information 10 includes the character name 101, the character image 102, the capability information 103, and the effect information 104. In addition, the character information 10 includes combo information 105 and cost information 106.

As in the leader card 21, the character name 101 is the name of a character associated with the card. In the example illustrated in FIG. 5, “Umekouji” is written.

As in the leader card 21, the character image 102 is the image of a character associated with the card.

As in the leader card 21, the capability information 103 is a parameter for the ability of a character associated with the card. In the example of FIG. 5, the power value “20000” is written.

The effect information 104 is recorded with skill information related to the effect exercised at the time of attack. In the example of FIG. 5, as the skill information, “When you are attacked and defeated with this card, the life is decreased by one” is written.

The combo information 105 is information related to power value for increasing the power value of other game cards positioned in the battle area. In the example illustrated in FIG. 5, “+5000” is written as the combo information 105.

The cost information 106 is information on the cost necessary for placing the battle card 22 from the hand of cards to the battle area. For example, the battle card 22 can be placed on the battle area by changing game cards positioned in an energy area, for example, from the active state to the rest state for the number of cards equivalent to the numerical value written in the cost information 106. In the example of FIG. 5, “3” is written as the cost information 106. Note that in the following, changing game cards positioned in an energy area from the active state to the rest state will be described as “paying the cost”.

The card information 11 includes the card type name 112, the card type symbol 113, the color information 114, the rarity level 115, and the card identification information 116.

The card type name 112 is information indicating the type of a card. In the example of the battle card 22 illustrated in FIG. 5, the card type name 112 is recorded with “Battle”.

The card type symbol 113 is recorded with a battle symbol (a second symbol) that indicates the battle card 22. The battle symbol may be a symbol that can recall the role of the battle card 22 so as to visually identify the battle card.

The color information 114 indicates information on the color of the card. A player refers to the color information 114 of the leader card 21, and constructs a deck using the battle cards 22 and the extra cards 23 with the same color information.

The rarity level 115 indicates the rarity level of the game card. The example illustrated in FIG. 5 exemplifies a case where the rarity level is one.

The card identification information 116 is recorded with identification information that uniquely identifies the game card. In the example of FIG. 5, “002” is written as the card identification information 116.

### Extra Card 23

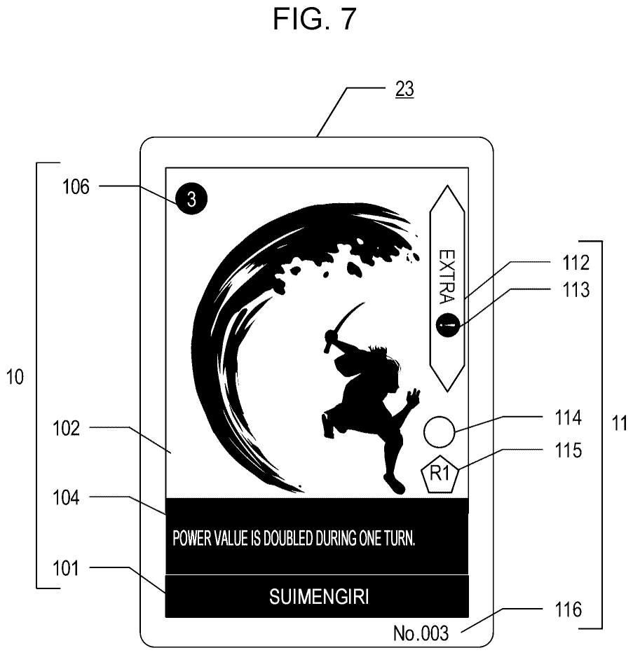

The extra card 23 (the first type third game element) will be described. FIG. 7 is a view for explaining an example of the front surface of the extra card 23. As illustrated in FIG. 7, the image of an associated character is shown on the front surface of the extra card 23. The back surface of the extra card 23 is the same as that of the battle card 22. Therefore, the back surface of the extra card 23 is the same as that of the battle card 22 illustrated in FIG. 6.

The extra card 23 includes the character information 10 and the card information 11.

The character information 10 includes the character name 101, the character image 102, the effect information 104, and the cost information 106.

The character name 101 is the name of a character associated with the card. In the case of the extra card 23, the character name 101 is the name of a characteristic scene, a visual scene, a landscape, a background, a building, possession of the character, and an event that appear in a work. In the example of FIG. 7, “Suimengiri” is written.

The character image 102 is the image of a character associated with the card, and in the image, a characteristic scene, a visual scene, a landscape, a background, a building, possession of the character, or an event that appear in a work is expressed along with the character.

The effect information 104 is recorded with skill information related to the effect exercised at the time of attack. In the example of FIG. 7, as the skill information, “The power value is doubled during one turn” is written.

The cost information 106 is information on the cost necessary for placing the extra card 23 from the hand of cards to the battle area. In the example of FIG. 7, “3” is written as the cost information 106.

The card information 11 includes the card type name 112, the card type symbol 113, the color information 114, the rarity level 115, and the card identification information 116.

The card type name 112 is information indicating the type of a card. In the example of the extra card 23 illustrated in FIG. 7, the card type name 112 is recorded with “Extra”.

The card type symbol 113 is recorded with an extra symbol (a third symbol) that indicates the extra card 23. The extra symbol may be a symbol that can recall the role of the extra card 23 so as to visually identify the extra card.

The color information 114 indicates information on the color of the card. A player refers to the color information 114 of the leader card 21, and constructs a deck using the battle cards 22 and the extra cards 23 with the same color information.

The rarity level 115 indicates the rarity level of the game card. The example illustrated in FIG. 7 exemplifies a case where the rarity level is one.

The card identification information 116 is recorded with identification information that uniquely identifies the game card. In the example of FIG. 7, “003” is written as the card identification information 116.

### Second Type Game Element

The second type game element will be described.

The second type game element in the present embodiment is a game element used for trading in a game, and is called an in-game currency. The second type game element includes a paid-for second type game element (second type first game element) which can be obtained by a player paying a price (e.g., money), and a free of charge second type game element (second type second game element) which is granted from a game-administration side by achieving a predetermined condition (e.g., a mission prepared by a game-administration side) without exchanging with a price (e.g., money) by a player. The paid-for second type game element (the second type first game element), and the free of charge second type game element (the second type second game element) are primarily used for exchange (purchase) with the above-mentioned first type game element (game card). In the following description, the paid-for second type game element (the second type first game element) is described as the paid-for currency, and the free of charge second type game element (the second type second game element) is described as the free of charge currency.

Next, the configuration of each device will be described.

### Configuration of Player Terminal 1

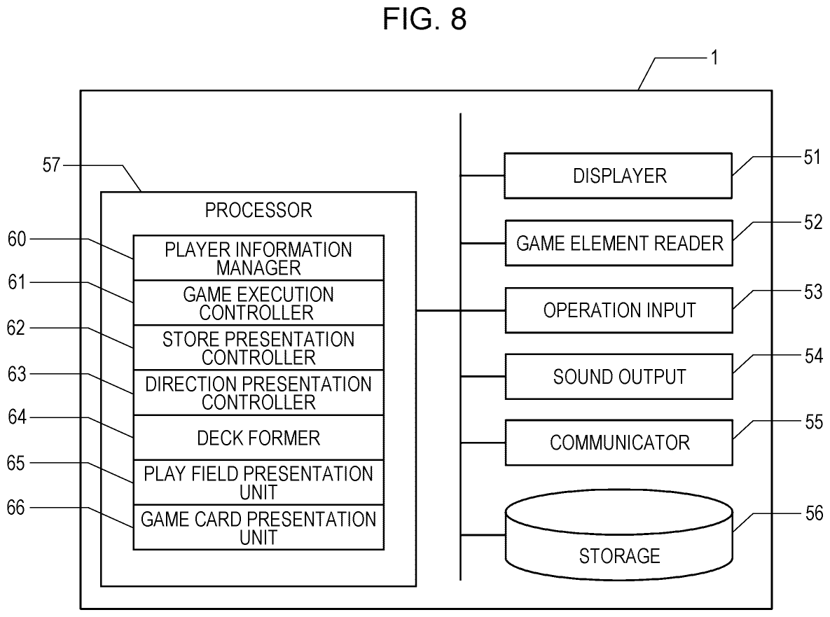

FIG. 8 is a block diagram illustrating a functional configuration example of the player terminal 1.

As illustrated in FIG. 8, the terminal 1 includes a displayer 51, a game element reader 52, an operation input 53, a sound output 54, a communicator 55, a storage 56, and a processor 57.

The displayer 51 displays various game screens based on an input image signal. The function of the displayer 51 can be implemented by a display device such as a flat panel display like a liquid crystal, a cathode-ray tube (CRT), a projector, or a head mounted display. In the example of a personal computer of FIG. 2, the displayer 51 corresponds to the display 11.

The game element reader 52 is a reader that reads character information from a game card which is a real article, the character information appearing in a game. The game element reader 52 can read identification information and the like of a game card possessed by a player by setting (arranging) the character that appears in a fighting game to the game element reader 52 using the game card.

The operation input 53 is for a player to input various operations related to a game, and an operation input signal according to an operation input is output to the processor 57. The function of the operation input 53 can be implemented not only by a device directly operated by a player's fingers, such as a keyboard, a mouse, a touch operation pad, a home button, a button switch, a joystick, or a track ball, but also by a device that detects motion and posture, such as an acceleration sensor, an angular velocity sensor, an inclination sensor, or a geomagnetic sensor. In the example of the personal computer in FIG. 2, the operation input 53 corresponds to a keyboard 12.

The sound output 54 is for outputting sound effects related to a game based on an input sound signal.

The communicator 55 implements communication by connecting to the communication line N. The function of the communicator 55 can be implemented by e.g., a wireless communication device, a modem, a terminal adaptor (TA), the jack of a wired communication cable, or a control circuit.

The storage 56 pre-stores a program, and data or the like used during execution of the program, or temporarily stores the data for each process, the program causing the player terminal 1 to operate, and implementing various functions of the player terminal 1. The storage 56 can be implemented by e.g., a solid state drive using an IC memory such as a RAM, a ROM, or a flash memory, a magnetic disk such as a hard disk, or an optical disk such as a CD-ROM and a DVD.

The storage 56 stores a system program and a game program. The system program implements the basic functions of the player terminal 1 as a computer. The game program causes the processor 57 to exert the later-described functions. When a player completes account registration, the program is distributed from the game server 2 or another application distribution server. The storage 56 also stores a database necessary to execute a game. In the present embodiment, the storage 56 stores a player information database D1, and a game element information database D2.

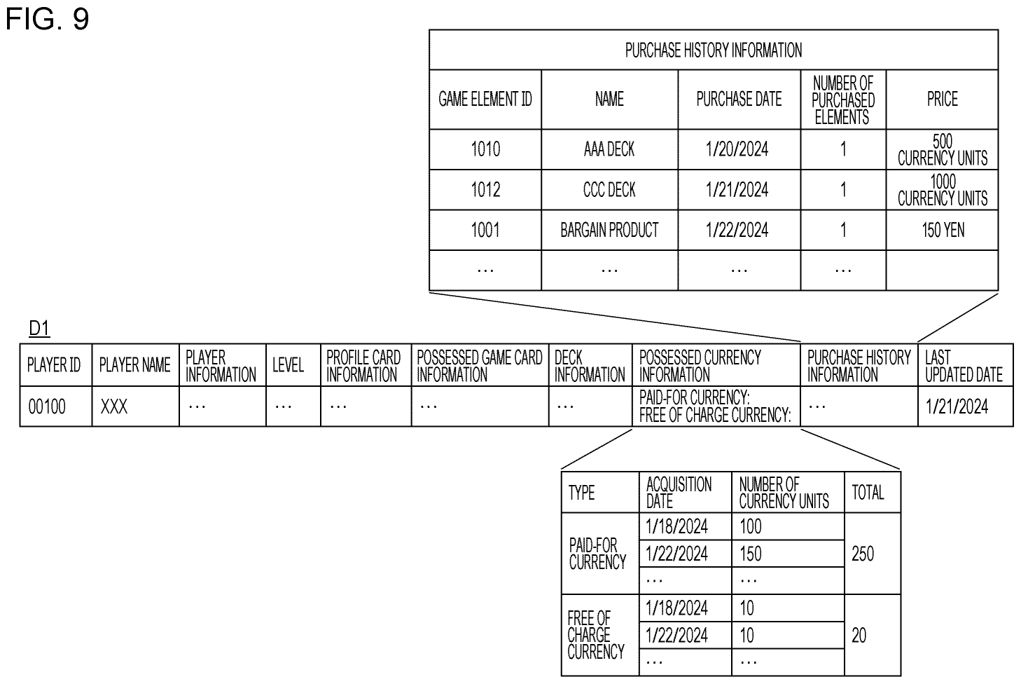

The player information database D1 is a database that stores various types of information on players. FIG. 9 is a table illustrating an example of the player information database D1. The player information database D1 includes a field for player ID, a field for player name, a field for player information, a field for level, a field for profile card information, a field for possessed game card information, a field for deck information, a field for possessed currency information, a field for purchase history information, and a field for last updated date. These pieces of information are associated with each other, and stored.

The field for player ID is for recording identification information to identify a player. The field for player name is for recording e.g., a nickname. The field for player information is for recording experience points or the like obtained through play of a fighting game. The field for level is for recording the level of a player achieved by accumulation of experience points. The field for profile card information is for recording information on the later-described profile card. The field for possessed game card information is for recording the game card identification information (game card ID) of a game card possessed by a player. The field for deck information is for recording information on a deck constructed from game cards by a player, that is, for recording the game card IDs of the game cards included in the deck.

The field for possessed currency information is for recording information on the in-game currency possessed by a player, specifically, the amount of each of paid-for currency and free of charge currency. Specifically, for each of paid-for and free of charge types, the date of acquisition of the currency, the acquired currency units, and the total amount are written. The field for purchase history information is for recording the history of purchase of the game cards, and in-game currency purchased by a player. Specifically, the game element ID of a purchased game element, the name of the game element, the purchase date, and the number of purchased game elements are written. The field for last updated date is for recording the last updated date of the player information database D1.

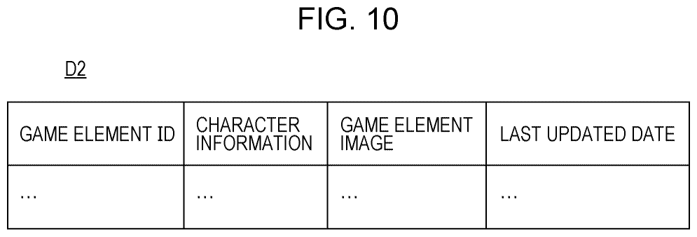

The game element information database D2 is a database to store information on the game element that appears or is used in a game. FIG. 10 is a table illustrating an example of the game element information database D2. The game element information database D2 includes a field for game element ID, a field for character information, a field for game element image, and a field for last updated date. These pieces of information are associated with each other, and stored. The field for game element ID is for recording identification information (game card ID) to identify the game element such as a game card. The field for character information is for recording the character information (for example, the type of game element, the profile information, the ability value, and the rarity information) of a character which has transformed into a game element. The field for game element image is for recording the image data of a game element itself (e.g., a game card) or the image data of a character which has transformed into a game element. Note that the image data includes a still image and a video. The field for last updated date is for recording the last updated date of the game element information database D2.

Note that these databases can be successively downloaded via the game server 2 for addition to or change in the characters used in a game.

The processor 57 comprehensively controls the operation of the terminal 1 based on the programs and data stored in the storage 56, and various input signals from the operation input 53. The function of the processor 57 can be implemented by e.g., a microprocessor such as a CPU or a GPU, and electronic parts such as an ASIC, and an IC memory. As primary functional units, the processor 57 includes a player information manager 60, a game execution controller 61, a store presentation controller 62, a direction presentation controller 63, a deck former 64, a play field presentation unit 65, and a game card presentation unit 66.

The player information manager 60 manages the information on players using the player information database D1. The player information manager 60 uses the player information database D1 to manage game elements such as player information like a player ID and a player name, possessed game cards, in-game currency, and decks formed by a player. When those pieces of information are updated, the player information manager 60 updates the player information database D1, and records the update date.

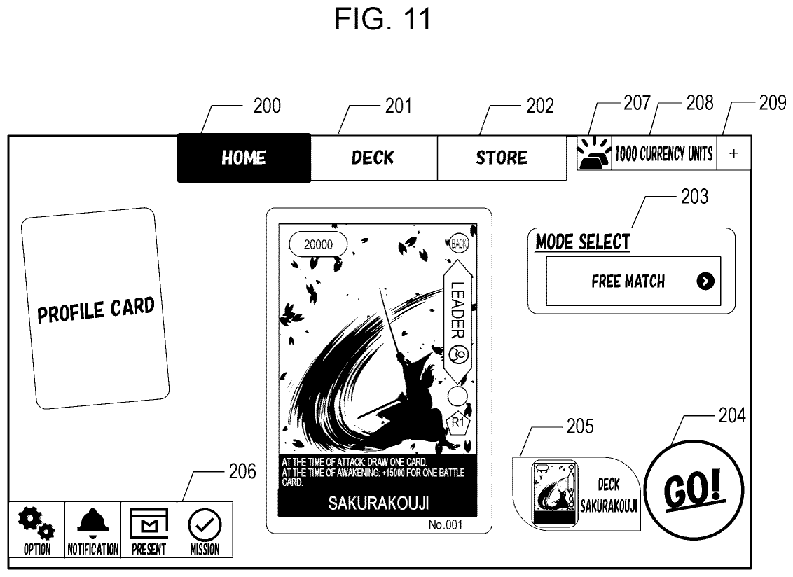

The game execution controller 61 controls and managed the progress of the entire game. For example, the game execution controller 61 displays a menu screen of a home screen or the like, and performs a process selected by a player. FIG. 11 is a view illustrating an example of a home screen. The home screen in FIG. 11 displays a home screen tab 200 for the home screen, a deck tab 201 to make a transition to a deck screen for forming a deck, a store tab 202 to make a transition to a store screen for purchasing a game card, a fighting mode selection button 203 to select to fighting mode for a fight using a deck, a fighting button 204 to make a transition to a fight in the selected fighting mode, an icon 205, a reward button 206 to make a transition to a reward screen related to reward of a mission, an in-game currency icon 207, an in-game currency balance (amount of possession) icon 208, and an in-game currency providing screen transition button 209 to make a transition to a purchase screen for in-game currency. Note that the in-game currency balance (amount of possession) icon 208 shows the total of paid-for currency units and free of charge currency units. On the icon 205, the deck name of a deck currently selected, and the leader card included in the deck are displayed.

The game execution controller 61 executes a fighting game between players, and when victory or defeat of the game is determined, the player information, the level and the like of the player information database D1 are updated with a fighting result, and the experience points, level, rank which have been changed by the fighting. The date of update is recorded on the field for last updated date as the last updated date.

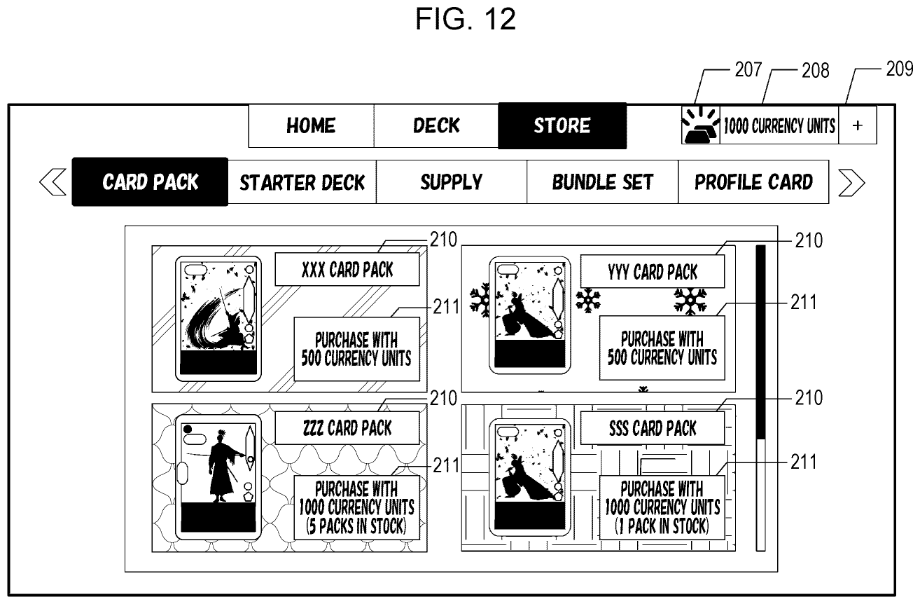

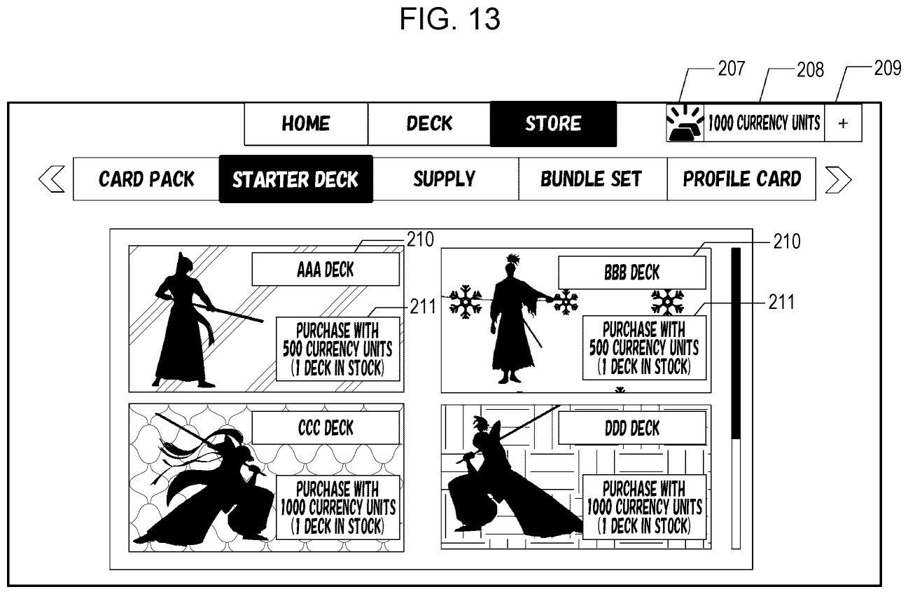

When the store tab 202 for the home screen is selected, the store presentation controller 62 presents a store screen for trading the game elements (such as a game card, in-game currency) to selectably present the game elements to be traded on the store screen. FIGS. 12 and 13 are views illustrating an example of a store screen. FIG. 12 is an example of a store screen for purchasing a card pack (set of game cards), FIG. 13 is an example of a store screen for purchasing a starter deck (set of game cards), and providable (grantable) card packs are selectably presented. In the area of card packs, a name 210 of each card pack, and an option 211 for purchasing the card pack are displayed. Here, the provision (grant) includes obtaining by exchanging with a price by a player, and providing (granting) by an administration side without needing to pay for price.

The providable game elements include the ones provided with restrictions, and the ones provided without restrictions. The game elements with restrictions include, for example, the ones with restrictions on the number of times of provision (grant), and the ones which are providable (grantable) only in a predetermined time period. The restrictions on the number of times of provision (grant) of game element is, for example, restrictions on the number of times of provision for one player, or restrictions on the providable number of times of provision for all players. Also, game elements without restrictions on the provision (grant), and game elements with restrictions on the provision (grant) may be displayed collectively or singly. In the example of FIG. 12, “XXX card pack” and “YYY card pack” have no restrictions on the number of times of provision, but “ZZZ card pack” and “SSS card pack” have restrictions on the number of times of provision. In the example of FIG. 13, all of “AAA deck” “BBB deck” “CCC deck” and “DDD deck” have restrictions on the number of times of provision. In this manner, in addition to the game elements that are sold normally, the game elements that are provided (granted) only in a specific number or in a specific time period are supplied, thus the interest of each player to the game elements can be maintained continually.

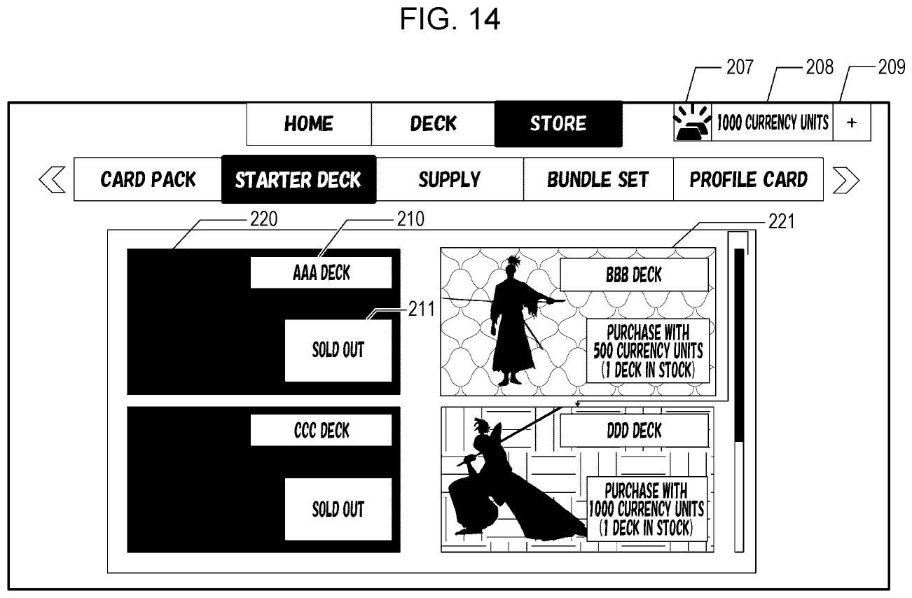

In addition, the game elements presented on the store screen include not only currently tradable game elements, but also game elements which were providable in the past, but are currently untradable. The currently untradable game elements are, for example, the game elements when restrictions on the number of times of grant of game element are provided per player and the restricted limit is reached, or when the number of times of provision for all players is predetermined and the number of times of provision (grant) has reached the number (sold-out state). The store presentation controller 62 presents currently unprovidable game elements to a player to be distinguishable from currently providable game elements, so that the currently unprovidable game elements cannot be selected. FIG. 14 is a view illustrating an example of display of currently providable game elements and currently unprovidable game elements on the store screen. In the example of FIG. 14, an area 220 for “AAA deck” and “CCC deck” in a sold-out state is expressed in black to be distinguishable from an area 221 for “BBB deck” and “DDD deck” in a providable state, and display of an option 211 for “AAA deck” and “CCC deck” is changed to “SOLD OUT” indicating a sold-out state, and presented as unselectable by a player. In this manner, currently untradable game elements are presented as unselectable, thereby the player can recognize the game elements provided in the past and do not select from the currently untradable game elements, thus the convenience of players is improved.

The store presentation controller 62 also provides or grants in-game currency. As illustrated in FIGS. 11 to 14, instead of using transition to the in-game currency providing screen by a tab, the in-game currency icon 207, the in-game currency balance icon 208 for the in-game currency of a player, and the in-game currency providing screen transition button 209 to make a transition to the in-game currency providing screen are displayed on each of the home screen caused by the home screen tab 200, the deck formation screen caused by the deck tab 201, and the store screen caused by the store tab 202.

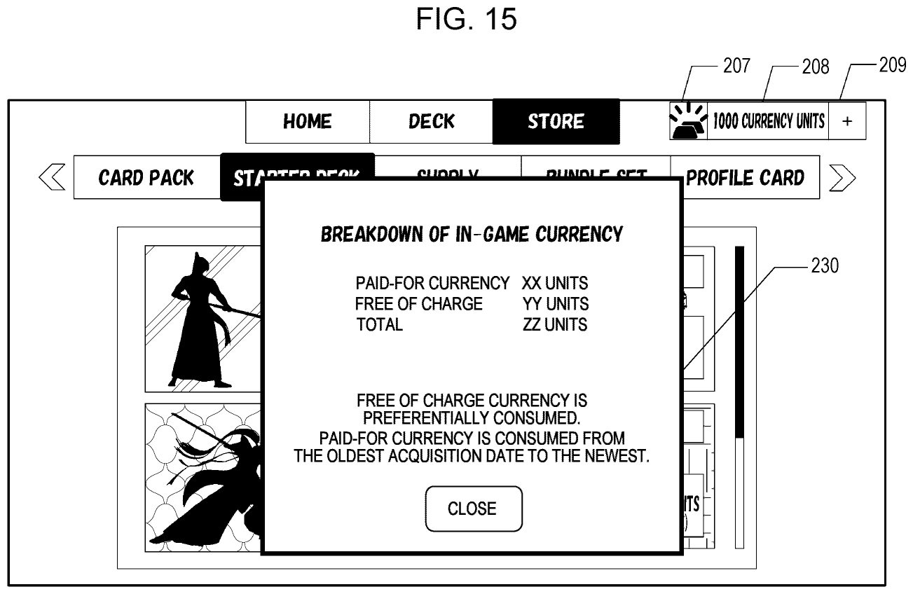

When one of the in-game currency icon 207 and the in-game currency balance icon 208 for the in-game currency of player is selected, the store presentation controller 62 refers to the field for possessed currency information of the player information database D1, and displays the breakdown between the paid-for and free of charge in-game currency units currently possessed by the player. FIG. 15 is a view illustrating an example of display of breakdown between paid-for and free of charge in-game currency units currently possessed. In the example of FIG. 15, the balance of paid-for currency among the in-game currency currently possessed by the player, and the balance of free of charge currency among the in-game currency currently possessed by the player are displayed. As the price for purchasing a game element, it is displayed that free of charge currency is consumed preferentially, and paid-for currency is consumed from the oldest date of acquisition to the newest date.

In this manner, the in-game currency icon 207, the in-game currency balance icon 208, and the in-game currency providing screen transition button 209 are presented on each screen, thus the player can recognize the balance of the in-game currency currently possessed, and the breakdown between paid-for and free of charge in-game currency, thus can make a transition from each screen to the in-game currency providing screen for obtaining necessary in-game currency.

When the in-game currency providing screen transition button 209 is selected, the store presentation controller 62 makes a transition to the in-game currency providing screen. On the in-game currency providing screen, the store presentation controller 62 presents the currently providable in-game currency.

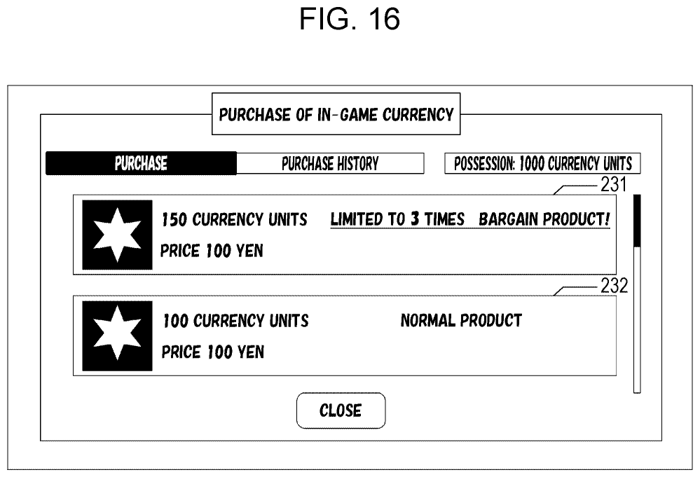

FIG. 16 is a view illustrating an example of the in-game currency providing screen. In the example of FIG. 16, a first paid-for currency pack 231 and a second paid-for currency pack 232 are presented on the in-game currency providing screen. The first paid-for currency pack 231 costs 150 currency units for 100 yen, and the second paid-for currency pack 232 costs 100 currency units for 100 yen. Like this, the first paid-for currency pack 231 and the second paid-for currency pack 232 have different provided amounts for a predetermined price. In other words, the first paid-for currency pack 231 offers a better deal. However, there is an upper limit to the number of times of provision (grant) of the first paid-for currency pack 231 for one player. In the example of FIG. 16, the upper limit to the number of times of provision (grant) of the first paid-for currency pack 231 is three for one player. In contrast, there is no upper limit to the number of times of provision (grant) of the second paid-for currency pack 232 for one player.

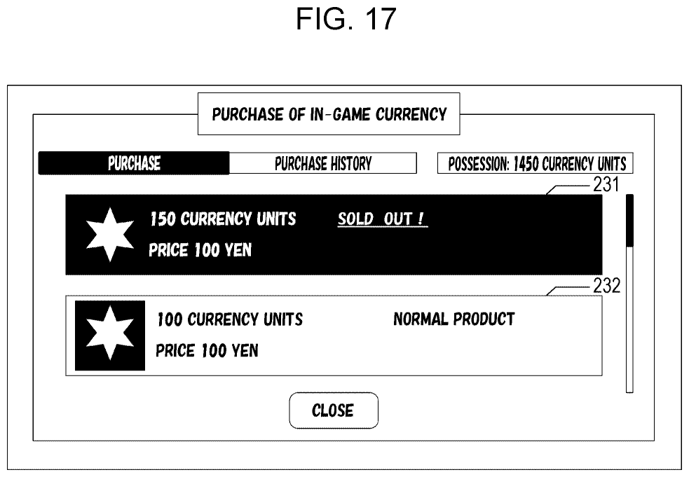

The store presentation controller 62 refers to the purchase history information of the player in the player information database D1, and when the upper limit of the number of times of provision (grant) of the first paid-for currency pack 231 is reached, notifies of a sold-out state due to this situation, and presents the first paid-for currency pack 231 as unselectable. FIG. 17 is a view illustrating an example of when the number of times of provision (grant) of the first paid-for currency pack 231 has reached an upper limit, resulting in a sold-out state.

As described above, in addition to the game elements that are sold normally, the game elements that are provided (granted) only in a specific number or in a specific time period are supplied, thus the interest of each player to the game elements can be maintained continually.

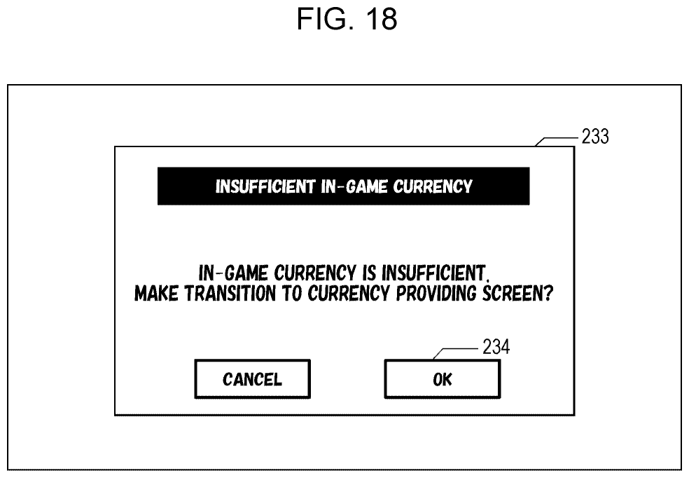

In addition, when a game element such as a game card is purchased on the store screen for purchasing game element, if the in-game currency (the total of the paid-for currency units and the free of charge currency units) for the price of the game element is insufficient, the store presentation controller 62 may notify of insufficiency of the in-game currency, and as a method to make a transition to the in-game currency providing screen, may display a screen from which a transition can be made to the in-game currency providing screen. FIG. 18 is a view illustrating an example of a screen to be displayed when the in-game currency for the price of a game element is insufficient. In the example of FIG. 18, a notification 233 indicating that the in-game currency for the price of a game element is insufficient, and a button 234 which can make a transition to the in-game currency providing screen are displayed.

The direction presentation controller 63 orchestrates the direction for opening game elements such as game cards purchased on the store screen. In the present embodiment, a description will be given using an example of a set of game cards such as a card pack and a deck. As mentioned above, each game card has a rarity level, and the rarity is divided into five scales. In addition, each game card has an attribute such as leader card, and battle card. These game cards have their values, and a smaller number of game cards with a higher value is provided. A set such as a card pack is a set of multiple game cards having various value information such as these rarities and attributes. When purchasing a set (pack) such as a card pack, a player cannot tell the value of game elements such as game cards included in the pack. However, the player may find joy in knowing what kind of values are possessed by the game cards included in the purchased pack. Thus, a pack opening direction which reveals what kind of values are possessed by the game cards included in the purchased pack is an important direction that enhances the enjoyment of the game.

The direction presentation controller 63 performs an opening direction for a granted pack using the pack information transmitted when the pack is provided from the server 2. The pack information includes the game element ID of each game element included in the pack. The direction presentation controller 63 obtains value information (such as rarity information, attribute information) of the game element ID in the pack information from the game element information database D2, and performs an opening direction for the pack according to the value information.

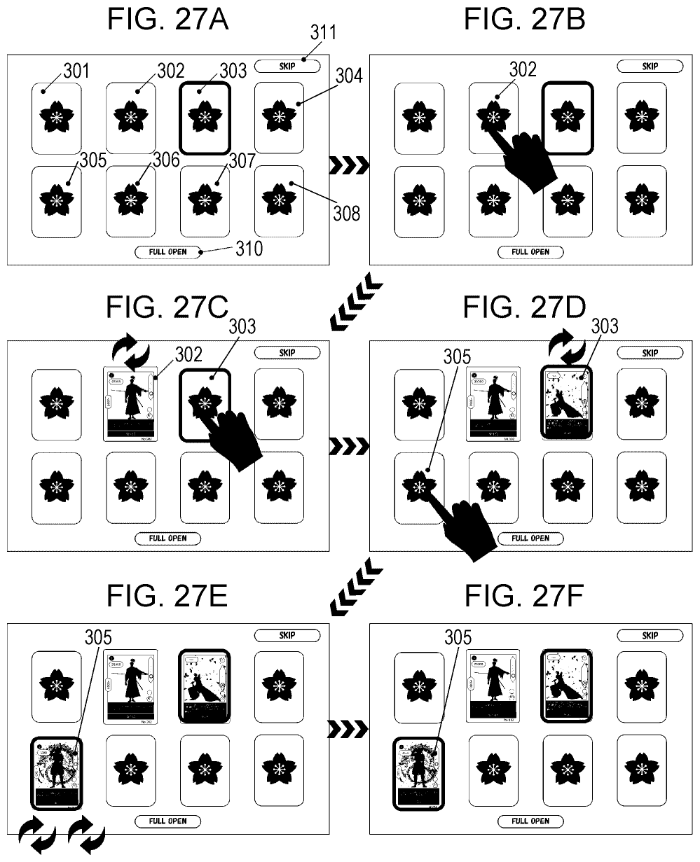

A specific example of an opening direction performed by the direction presentation controller 63 will be described below. In the following, a description will be given using an example of a game card pack including eight game cards as an instance of a set of game elements, and an example of rarity information as an instance of value information. FIGS. 27A to 27F show views for explaining an opening direction example.

The direction presentation controller 63 receives pack information on the pack provided from the server 2. Here, the game element IDs of eight game cards included in the received pack information are assumed to be game element ID “2021”, game element ID “2056”, game element ID “2078”, game element ID “2088”, game element ID “2147”, game element ID “2159”, game element ID “2299”, and game element ID “2347”.

The direction presentation controller 63 obtains rarity information corresponding to the game element IDs from the game element information database D2. The rarity information corresponding to the game element IDs is as follows:

The rarity information for game element ID “2021” is “1”.

The rarity information for game element ID “2056” is “1”.

The rarity information for game element ID “2078” is “3”.

The rarity information for game element ID “2088” is “1”.

The rarity information for game element ID “2147” is “5”.

The rarity information for game element ID “2159” is “1”.

The rarity information for game element ID “2299” is “1”.

The rarity information for game element ID “2347” is “1”.

The direction presentation controller 63 pre-stores a threshold value for predetermined rarity information, and performs a different direction depending on whether the rarity information of granted game cards exceeds the threshold value. In the following example, the threshold value for the rarity information is assumed to be “2”.

As a first stage direction, the direction presentation controller 63 selectably presents the eight game cards 301 to 308 with the back surfaces (character information is unrecognizable) having the same picture pattern shown. When the game cards 301 to 308 are leader cards, character information is written on both the front and back surfaces, but the back surfaces with the same picture pattern are displayed, where character information is formally unrecognizable from the back surfaces. For a game card with a threshold value exceeding “2”, the outer edge of the back surface of the game card is thickened (a first mode). In contrast, for a game card with a threshold value not exceeding “2”, the outer edge thereof has a normal thickness (a second mode). However, the game card having highest rarity information among game cards with a threshold value exceeding “2” is in the second mode as in a game card with a threshold value not exceeding “2”.

Specifically, in the game cards 301 to 308 of FIGS. 27A to 27F, the game card 301 corresponds to the game element ID “2021” with rarity information “1”, the game card 302 corresponds to the game element ID “2056” with rarity information “1”, the game card 303 corresponds to the game element ID “2078” with rarity information “3”, the game card 304 corresponds to the game element ID “2088” with rarity information “1”, the game card 305 corresponds to the game element ID “2147” with rarity information “5”, the game card 306 corresponds to game element ID “2159” with rarity information “1”, the game card 307 corresponds to game element ID “2299” with rarity information “1”, and the game card 308 corresponds to game element ID “2347” with rarity information “1”. Among the game cards 301 to 308, the game cards with a threshold value exceeding “2” are the game card 303 and the game card 305. The game card 305 has the highest rarity information.

The direction presentation controller 63 indicates that the game card 303 has high rarity information in the first mode in which the outer edge of the back surface of the game card 303 is thickened. In contrast, other game cards excluding the game card 303 are presented in the second mode (FIG. 27A).

A player selects one of game cards presented. The direction presentation controller 63 performs a second stage direction for the selected game card.

Here, the player is assumed to select the game card 302 (FIG. 27B). As the second stage direction, the direction presentation controller 63 performs a first direction (one flip) in which the game card 302 is turned back to front, and displays the front surface of the game card 302, so that the character information is recognizable (FIG. 27C).

Next, the player is assumed to select the game card 303 (FIG. 27C)). As the second stage direction, the direction presentation controller 63 performs a direction (one flip) in which the game card 303 is turned back to front, and displays the front surface of the game card 303, so that the character information is recognizable (FIG. 27D). At this point, the outer edge of the game card 303 is in the first mode which indicates high rarity information.

Furthermore, the player is assumed to select the game card 305 (FIG. 27D). As the second stage direction, the direction presentation controller 63 performs a direction in which the game card 305 is turned back to front. The game card 305 is the game card having the highest rarity information of “5”. Thus, when direction of turning the game card 305 back to front is performed, the direction presentation controller 63 increases the number of flips (for example, two flips) to perform the second direction in order to indicate that the game card 305 is different from the other game cards (FIG. 27E). The direction presentation controller 63 displays the front surface of the game card 305, so that the character information is recognizable (FIG. 27F). At this point, the outer edge of the game card 305 is in the first mode which indicates high rarity information. The above operation is performed until all the game cards are selected.

In this manner, as a method for direction of opening the game cards, a first direction method performed when rarity information does not exceed a threshold value, a second direction method performed when rarity information exceeds a threshold value, and a third direction method performed on a special game card when rarity information exceeds a threshold value are combined to perform direction of opening the game cards, thereby implementing a direction that is unexpected to the player and enhances the enjoyment of the game.

Note that in the above description, the first mode has one type, but may have multiple types according to the size of rarity information. For example, the color for outer edge may be determined for each rarity information, and the outer edge of each game card with the rarity information may have the color. In addition, the color for outer edge may be different according to the attribute of the game card.

The third direction method is performed on the game card having the highest rarity information, but is not limited thereto, and may be performed on game cards having multiple pieces of rarity information, or performed on game cards based on a combination of rarity information and attribute information. The first direction method and the second direction method may be applied for rarity information, and the third direction method may be applied to a special game card, for example, a leader card.

The deck former 64 presents a deck formation screen, and forms a deck from the possessed game cards. The deck is formed by predetermined number of leader cards 21, battle cards 22, and extra cards 23 (hereinafter may be collectively referred to as game cards). For example, when each game element is a virtual game card displayed on a computer, a deck is a card group consisting of a predetermined number of game cards. In the present embodiment, a configurable deck includes the game cards selected by a player. The player forms a deck using possessed game cards in advance, and executes a game. When a deck is formed, the total number of cards in the deck and the number of cards of each type are predetermined. In the present embodiment, the total number of game cards included in the deck is 30 or more and 35 or less, but not limited thereto. The game cards included in the deck always include one leader card 21, and the other game cards are the battle cards 22 and the extra cards 23 with the same color information as that of the leader card 21.

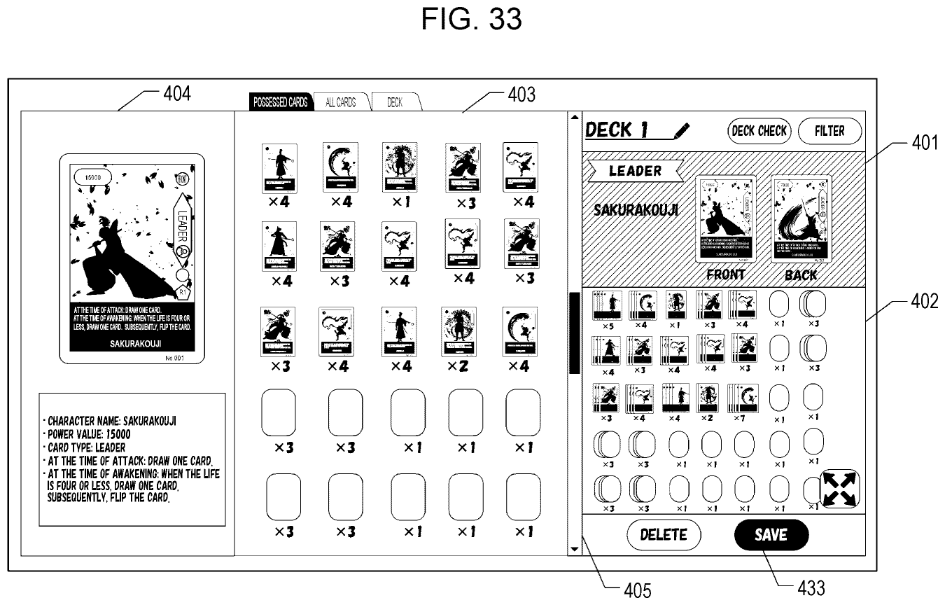

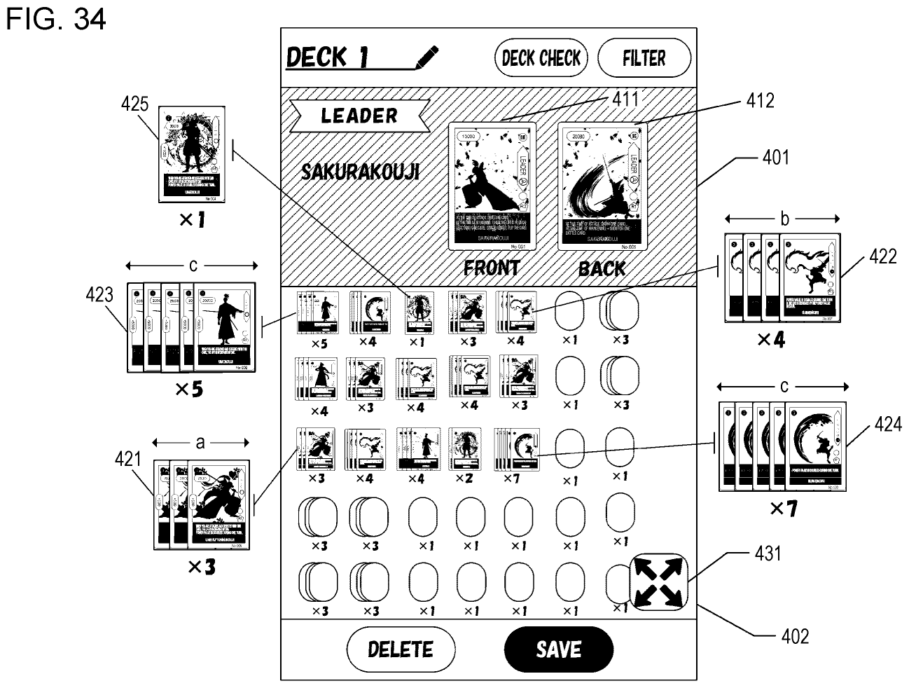

The deck formation screen presented by the deck former 64 will be described. FIG. 33 is a view illustrating an example of the deck formation screen. The deck formation screen includes a first area 401, a second area 402, a third area 403, and a fourth area 404. The first area 401 is the area where the leader card 21 included in the deck is displayed. The second area 402 is the area where the battle cards 22 and the extra cards 23 included in the deck are displayed. The third area 403 is the area where the leader cards 21, battle cards 22 and extra cards 23 possessed by the player are displayed. The fourth area is the area for displaying the detailed information on game cards selected from the game cards displayed in the first area 401, the second area 402, and the third area 403. The first area 401 and the second area 402 are vertically adjacent to each other, the first area 401 is disposed in an upper part, and the second area 402 is disposed in a lower part. The third area 403 is disposed adjacent to the first area 401 and the second area 402. The fourth area is disposed adjacent to the third area 403.

The deck former 64 reads the possessed game element IDs and the number of possessions from the player information database D1, and reads character information (including image information) corresponding to the game element IDs from the game element information database D2. The deck former 64 then displays, on the third area 403, the front surface (display surface of the character information) of one of game cards of each type in the leader card 21, battle cards 22 and extra cards 23 possessed by the player based on the read character information regardless of the number of possessions, and displays the number of possessions below the one game card. The player can place a desired leader card 21 in the first area 401 by selecting the leader card 21 from the displayed game cards in the third area 403, and moving (dragging and dropping) the leader card 21 to the first area 401. Similarly, the player can place a desired battle card 22 or extra card 23 in the second area 402 by selecting the battle card 22 or extra card 23 from the displayed game cards in the third area 403, and moving (dragging and dropping) the battle card 22 or extra card 23 to the second area 402. Note that the third area 403 is provided with the function of scroll 405, and scrolling allows all the leader card 21, battle cards 22 and extra cards 23 possessed by the player to be checked in the third area 403.

Next, the first area 401 and the second area 402 will be described in detail. FIG. 34 is a view for explaining the first area 401 and the second area 402. The deck former 64 displays, in the first area 401, a front surface 411 and a back surface 412 of the leader card 21 selected from the third area 403. The front surface 411 and the back surface 412 of the leader card 21 are fixed, and their sizes and placement positions cannot be changed. Note that only one type leader card can be displayed in the first area 401. The deck former 64 sets the background color of the first area to the same color as the attribute color (color information 114) of the leader card placed.

The deck former 64 displays, in the second area 402, the battle cards 22 or extra cards 23 selected from the third area 403 with the number of cards for each type presented. For each type of the cards, the deck former 64 displays card format images with part of the cards of the type superimposed. A format in which the card format images are superimposed is referred to as a first format. For example, there are three same game cards 421 included in the deck, thus the first format in which the three game cards 421 are stacked with the front surfaces up, and the number of game cards, “×3” below the game cards 421 are displayed in the second area 402. Similarly, there are four same game cards 422 included in the deck, thus the first format in which the four game cards 422 are stacked with the front surfaces up, and the number of game cards, “×4” below the game cards 422 are displayed in the second area 402. Similarly, there are five same game cards 423 included in the deck, thus the first format in which the five game cards 423 are stacked with the front surfaces up, and the number of game cards, “×5” below the game cards 423 are displayed in the second area 402. Note that the horizontal size of the first format increases with the number of game cards. For example, the horizontal size of the game cards 421 is “a”, the horizontal size of the game cards 422 is “b”, and the horizontal size of the game cards 423 is “c”, where a relationship of a<b<c holds.

However, when the number of same cards increases, the horizontal size becomes too large, and results in a smaller area where the game cards can be placed, thus the game cards greater in number than a predetermined number are displayed as a predetermined number of game cards in the first format. In the present embodiment, the predetermined number of game cards is five. For example, the number of the game cards 424 included in the deck is seven, which exceeds the predetermined number 5. Thus, for the game cards 424, the first format with five cards, and the number of game cards, “×7” below the first format are displayed in the second area 402. Therefore, the horizontal size of the game cards 424 and the horizontal size of the game cards 423 are the same, which is “c”.

The deck former 64 singly displays each of special game cards among the battle cards 22 or the extra cards 23 selected from the third area 403 without displaying each special game card in the first format regardless of the number of same game cards. This display format is referred to as a second format. The special game cards are e.g., a game card with a high rarity, or a parallel card and a premium card which are associated with the same character information as that of normal game cards, but have a different picture pattern. A game card 425 is a special game card, thus is displayed in the second format.

For placement of the game cards in the second area 402, maximum numbers of rows and columns for placing the game cards are set in advance. The maximum numbers of rows and columns are determined based on the type and number of game cards that can form a deck. In the present embodiment, the total number of game cards that can form a deck is 30 or more and 35 or less, thus as illustrated in FIG. 34, 5 rows and 7 columns are set, a maximum of 35 types can be placed when each special card is counted as one type, and a maximum of 35 game cards can be placed when each type is counted as one game card. In the initial presentation of game cards, the deck former 64 displays the game cards forming a deck in the first format and the second format with the maximum numbers of rows and columns so that the game cards forming the deck is visible as a list. Note that when the initial game cards are displayed, the number of rows and the number of columns may be changed as appropriate according to the types and the number of game cards forming the deck.

When the initial game cards are displayed, the game cards forming the deck are preferably visible as a list, but the display size of the game cards may be reduced. Thus, the deck former 64 has a function of displaying enlarged images of the game cards forming the deck. As illustrated in FIG. 34, the deck former 64 displays an enlargement button 431 in the second area, and when the enlargement button 431 is selected, the deck former 64 decreases the number of rows and the number of columns in the second area, and displays the game cards.

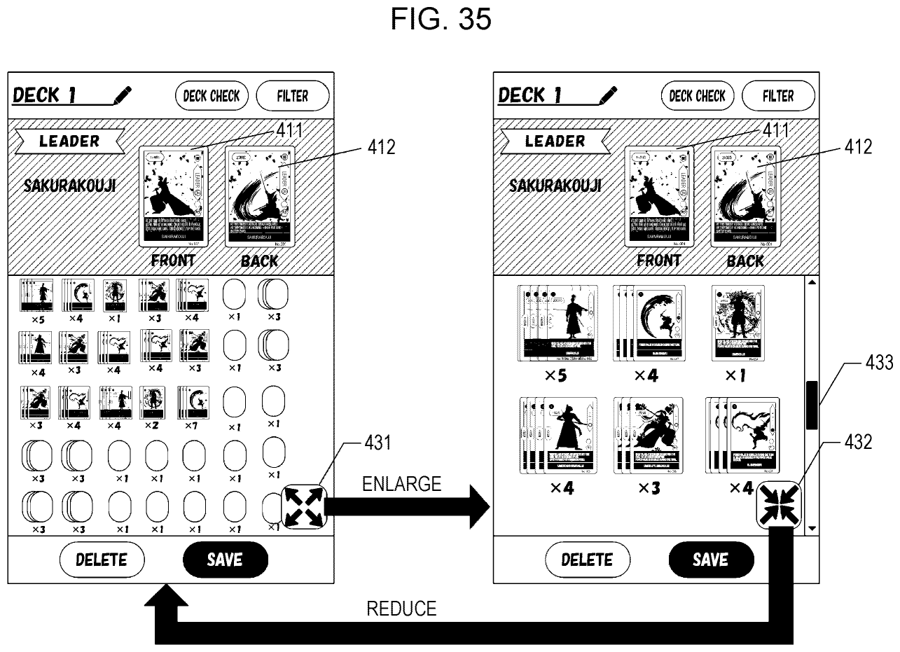

FIG. 35 is a view for explaining a function of enlarging the game cards in the second area. When the enlargement button 431 is selected, the deck former 64 changes the placement of the game cards from 5 rows by 7 columns to 2 rows by 3 columns so that the display of each type game card is enlarged. At this point, the reduction in the number of rows and the number of columns produces invisible game cards, so to make those game cards visible, a scroll 433 is displayed to allow all the game cards forming the deck to be viewed. When a reduction button 432 is selected, the deck former 64 returns the placement to maximum 5 rows and 7 columns again to allow all the game cards forming the deck to be viewed. Note that in the example of FIG. 35, two stages of enlargement and reduction are provided, but more stages of enlargement and reduction, such as 3 stages or 4 stages, may be further provided. In this case, in an intermediate stage, the enlargement button 431 and the reduction button 432 are displayed at the same time to allow a transition to each stage.

When a deck formation work by a player is finished, and a save button 433 is selected, the deck former 64 registers a deck in association with a deck name 434, the deck consisting of the leader card 21 placed in the first area 401, and the battle cards 22 and the extra cards 23 placed in the second area 402.

At the registration of the deck, the deck former 64 alerts the player when a deck unusable in a fighting game is attempted to be formed. In the present embodiment, the conditions (deck non-conforming criteria) for unusable deck in a fighting game are as follows:
(1) The number of game cards (the total number of game cards placed in the second area) forming the deck is less than 30.
(2) The number of game cards (the total number of game cards placed in the second area) forming the deck is greater than 35.
(3) The number of limited game cards (game cards having a special ability or skill) which can be included in the deck exceeds a restricted limit according to a game rule.
(4) The number of game cards of the same type exceeds a predetermined number.
(5) The deck includes a game card which is not possessed by the player.
(6) The deck does not include a leader card (no leader card 21 is present in the first area 401).
(7) The deck includes a game card with an attribute color different from the attribute color of the leader card (a game card with an attribute color different from the attribute color of the leader card is placed in the second area 402). These deck non-conforming criteria are an example, and other conditions may be added as appropriate.

When the save button 433 is selected, the deck former 64 determines whether the deck formation constructed with the game cards placed in the first area 401 and the second area 402 satisfies any of the deck non-conforming criteria. When the deck formation satisfies one of the deck non-conforming criteria, the deck former 64 notifies of the event. For example, when the deck non-conforming criteria are satisfied in part, the deck former 64 notifies of the following messages.
(1) When the number of game cards (the total number of game cards placed in the second area) forming the deck is less than 30, a pop-up text “Unusable for fighting because the number of cards in the deck is insufficient. Save the deck?” is displayed as a pop-up.
(2) When the number of game cards (the total number of game cards placed in the second area) forming the deck is greater than 35, a pop-up text “Unusable for fighting because the number of cards in the deck exceeds a limit. Save the deck?” is displayed as a pop-up.
(3) When the number of limited game cards (game cards having a special ability or skill) which can be included in the deck exceeds a restricted limit according to a game rule, “Unusable for fighting because the number of limited game cards exceeds a restricted limit. Save the deck?” is displayed as a pop-up.
(4) When the number of game cards of the same type exceeds a predetermined number, “Unusable for fighting because the number of game cards of the same type exceeds a predetermined number. Save the deck?” is displayed as a pop-up.
(5) When the deck includes a game card which is not possessed by the player, “Unusable for fighting because a game card not possessed is used to form the deck. Save the deck?” is displayed as a pop-up.
(6) When the deck does not include a leader card (no leader card 21 is present in the first area 401), “Unusable for fighting because a leader card is not used to form the deck. Save the deck?” is displayed as a pop-up.
(7) When the deck includes a game card with an attribute color different from the attribute color of the leader card (a game card with an attribute color different from the attribute color of the leader card is placed in the second area 402), “Unusable for fighting because a card with a color different from the color of the leader card is used to form the deck. Save the deck?” is displayed as a pop-up.

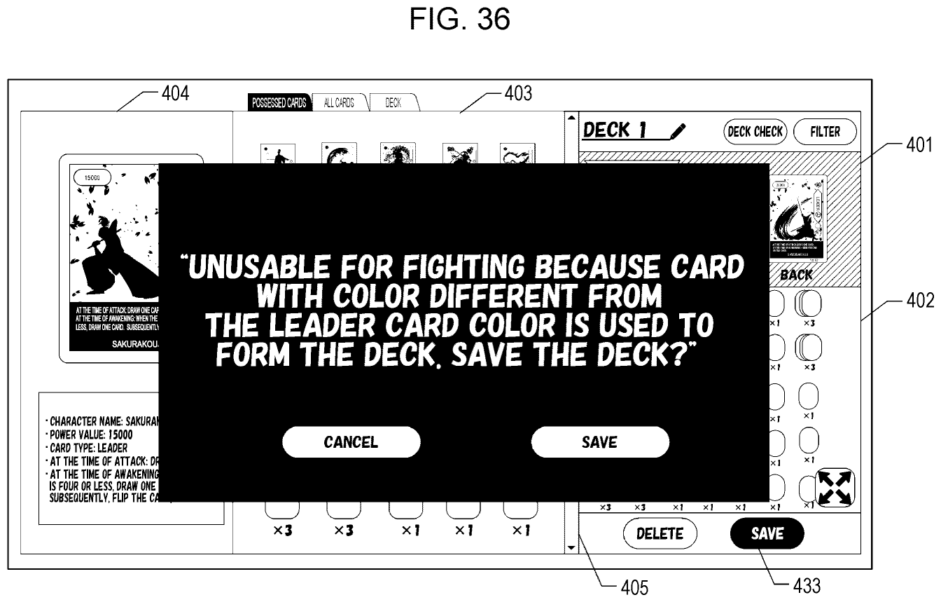

FIG. 36 is an example of popup display when the formed deck satisfies (7) deck non-conforming criterion.

Note that the deck non-conforming criteria may have a priority order. For example, a higher priority order is given to the condition, such as (6) a leader card is not present and (7) when the deck includes a game card with an attribute color different from the attribute color of the leader card, in which the game itself cannot be played, whereas a lower priority order is given to the condition, such as restrictions on the number of game cards forming the deck, in which the player has a disadvantage. According to the priority order, the player may be notified of satisfied deck non-conforming criteria successively. When the formed deck satisfies multiple deck non-conforming criteria, the player is preferably notified of all the multiple deck non-conforming criteria, but may be notified of only part thereof.

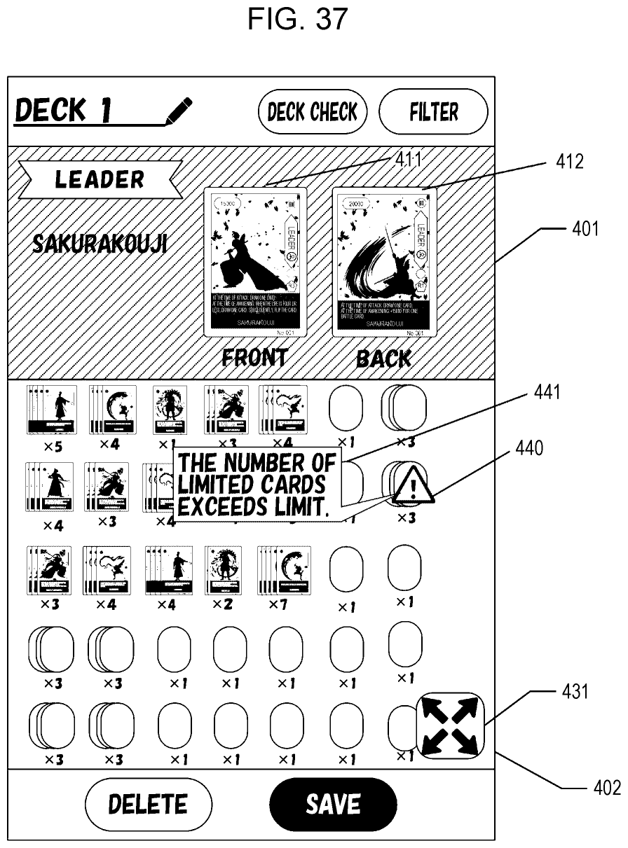

Because (3), (4) and (5) deck non-conforming conditions can be determined by the deck former 64 even in a deck formation process before registration of the deck, the deck former 64 may notify the player of the conditions accordingly. FIG. 37 is a view illustrating an example of display when a formed deck satisfies a deck non-conforming condition. As illustrated in FIG. 37, when a game card in the second area 402 satisfies a non-conforming condition, an alert icon 440 or notification 441 for the game card may be displayed.

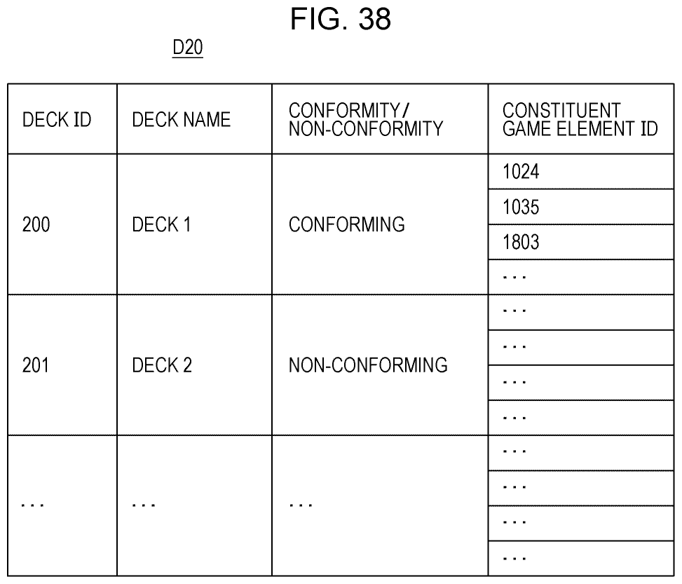

The deck former 64 registers, in the deck information database D20, a deck not satisfying any deck non-conforming condition and usable for a fighting game as a conforming deck, and registers, in the deck information database D20, a deck satisfying one of the deck non-conforming conditions and unusable for a fighting game as a non-conforming deck. FIG. 38 is an example of the deck information database D20. The deck information database D20 includes a field for deck ID, a field for deck name, a field for conformity/non-conformity, and a field for game element ID included in a deck. For a registered or saved deck, the deck former 64 records, in the deck information database D20, the deck ID, the deck name, conformity/non-conformity of the deck, the game element IDs of the game cards included in the deck with the date of update. The deck former 64 transmits the content of the deck information database D20 to the game server 2.

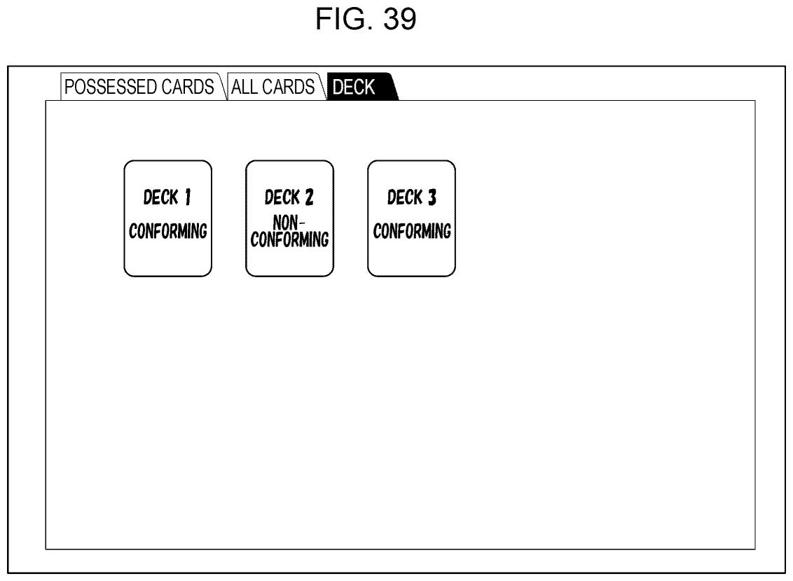

The deck former 64 can display a deck list screen including information on the deck names and conformity/non-conformity of the registered decks. FIG. 39 is an example of a registration deck list screen. Selecting one of the decks displayed as a list causes return to the deck formation screen, and the selected deck can be formed again.

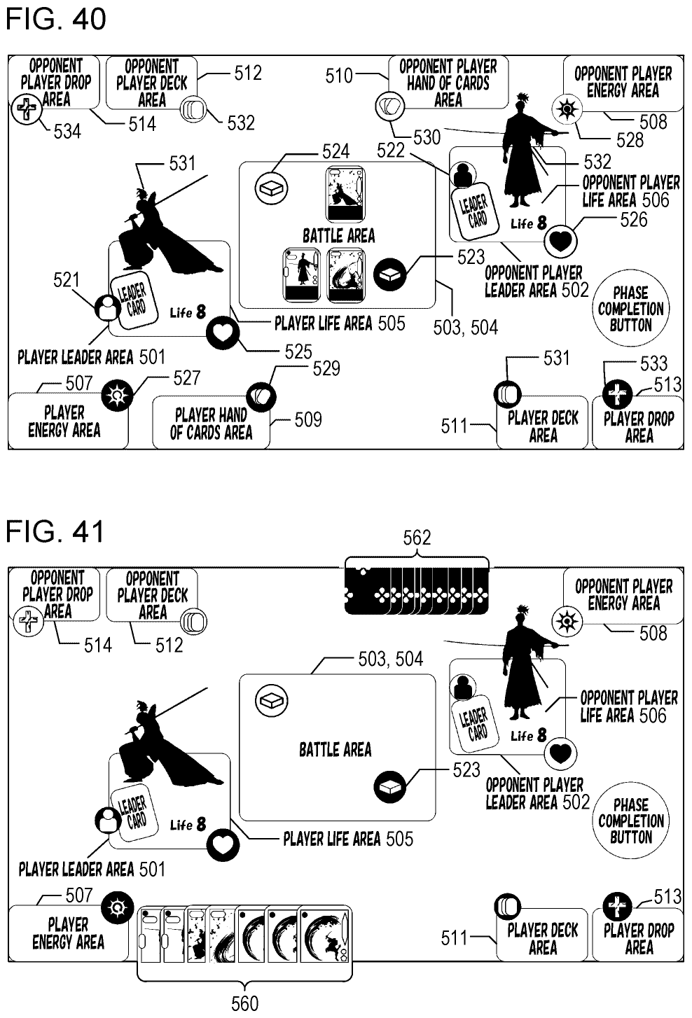

The play field presentation unit 65 presents a play field. Here, the play field will be described. FIG. 40 is a view illustrating an example of a play field presented by the play field presentation unit 65.

The play field is assigned a plurality of areas. The plurality of areas indicate the places where a player places game cards, and are arranged with space having a predetermined width. In the following description, the play field includes a leader area 501 of the player and a leader area 502 of the opponent player, a battle area 503 of the player and a battle area 504 of the opponent player, a life area 505 of the player and a life area 506 of the opponent player, an energy area 507 of the player and an energy area 508 of the opponent player, a hand of cards area 509 of the player and a hand of cards area 510 of the opponent player, a deck area 511 of the player and a deck area 512 of the opponent player, and a drop area 513 of the player and a drop area 514 of the opponent player. However, to enhance the direction performance, the boundary line of each area is not clearly shown except for the battle areas. These area names may be any name as long as each player can understand them.

Each area may be labeled with a name; however, in the present embodiment, instead of a name, an icon indicating the area is presented. In the present embodiment, the play field displays an icon 521 indicating the leader area 501 of the player, an icon 522 indicating the leader area 502 of the opponent player, an icon 523 indicating the battle area 503 of the player, an icon 524 indicating the battle area 504 of the opponent player, an icon 525 indicating the life area 505 of the player, an icon 526 indicating the life area 506 of the opponent player, an icon 527 indicating the energy area 507 of the player, an icon 528 indicating the energy area 508 of the opponent player, an icon 529 indicating the hand of cards area 509 of the player, an icon 530 indicating the hand of cards area 510 of the opponent player, an icon 531 indicating the deck area 511 of the player, an icon 532 indicating the deck area 512 of the opponent player, an icon 533 indicating the drop area 513 of the player, and an icon 534 indicating the drop area 514 of the opponent player.

The leader area 501 of the player and the leader area 502 of the opponent player are areas where the leader cards 21 are placed. However, these areas are different from other areas, and the character images of characters which have transformed into the leader cards 21 are displayed.

The battle area 503 of the player and the battle area 504 of the opponent player are areas where the battle cards 22 or the extra cards 23 of the player and the opponent player are placed. In the battle area 503 and the battle area 504, the character information of the card images of the placed battle cards 22 or extra cards 23 is displayed.

Although the battle cards 22 or the extra cards 23 are placed in the life area 505 of the player and the life area 506 of the opponent player, their card images are not displayed, and the number of placed cards is displayed (for example, Life 8).

The energy area 507 of the player and the energy area 508 of the opponent player are areas where one battle card 22 or one extra card 23 is placed from the hand of cards for each turn. The character information of the card image of the placed battle card 22 or extra card 23 is displayed.

The hand of cards area 509 of the player and the hand of cards area 510 of the opponent player are areas where a hand of cards selected from the deck of the player or the opponent player is placed. The character information of the card image of the placed battle card 22 or extra card 23 is displayed.

The deck area 511 of the player and the deck area 512 of the opponent player are areas where the deck of the player or the opponent player is placed. In these deck areas, the card images of the placed battle cards 22 or extra cards 23 are not displayed, and the number of remaining cards in the deck is displayed.

The drop area 513 of the player and the drop area 514 of the opponent player are areas where the battle card 22 is placed which has been attacked by the battle card 22 of the opponent player and knocked out (KO). The card images of the placed battle cards 22 or extra cards 23 are not displayed, and the number of cards is displayed.

When the above-described play field is presented, the play field presentation unit 65 does not display any boundary line other than the boundary line between the battle area 503 and the battle area 504 of the opponent player. This is due to consideration of the appearance of the play field. Alternatively, another area may be provided.

From a formed deck or hand of cards, the game card presentation unit 66 places game cards in each area and displays them. However, when the game cards are placed, the presentation format is different for each area. The areas are divided into disclosed areas and undisclosed areas. In the disclosed areas, the content (character information) of the game cards can be identified by both the player and the opponent player. In the undisclosed areas, the content (character information) of the game cards cannot be identified by at least one of the player or the opponent player. The disclosed areas are the leader areas 501, 502, the battle areas 503, 504, the energy areas 507, 508, and the drop areas 513, 514. In contrast, the undisclosed areas are the life areas 505, 506, the hand of cards areas 509, 510, and the deck areas 511, 512. Particularly, in the life areas 505, 506 and the deck areas 511, 512, both the player and the opponent player cannot identify the content (character information) of the game cards.

When placing game cards in a disclosed area, the game card presentation unit 66 presents the game cards so that the character information of the game cards is visible. For example, as in the game cards placed in the battle areas 503, 504 of FIG. 40, the game card presentation unit 66 presents the front surfaces (display surfaces of the character information) of the game cards. In contrast, in the hand of cards areas 509, 510 which are undisclosed areas, as in the hand of cards areas 509, 510 of FIG. 41, the game card presentation unit 66 presents game cards so that the character information of the game cards is visible to only one of the player or the opponent player. For the game cards placed in the life areas 505, 506 and the deck areas 511, 512 which are undisclosed areas, the images of the game cards are not presented, and only the number of the game cards is presented. This is because the cards with character information invisible to both the player and the opponent player do not need to be displayed in a card format so as to occupy the play field.

In addition, the game card presentation unit 66 has a function of presenting a viewing screen which allows the game cards placed in the areas to be viewed. Here, the viewing screen presented by the game card presentation unit 66 will be described.

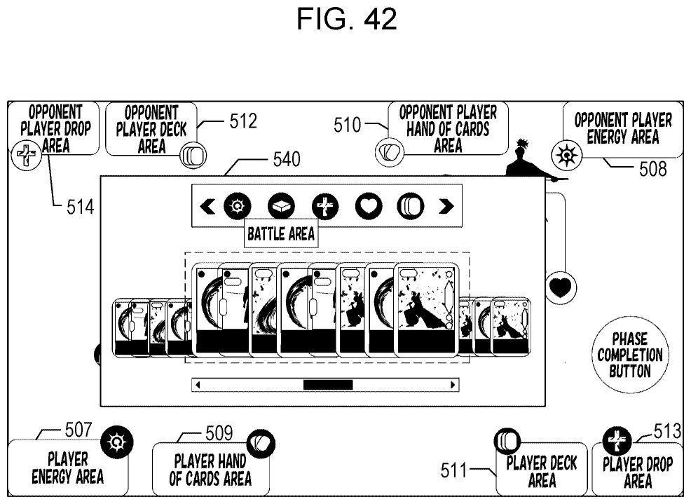

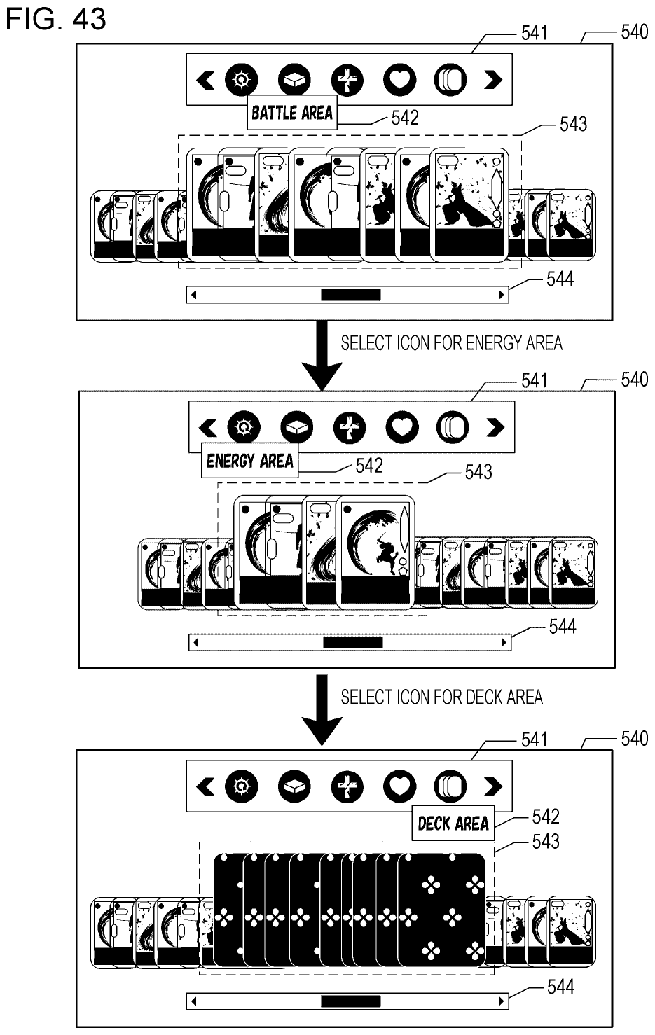

When one of the icons in the areas of the play field is selected by the player, the game card presentation unit 66 presents a viewing screen 540 on the play field. FIG. 42 is an example of the viewing screen 540 presented on the play field. The viewing screen 540 in FIG. 42 is an example viewing screen 540 when the icon 523 in the battle area of the player is selected.

The viewing screen 540 will be described in detail with reference to FIG. 43. The viewing screen 540 includes an icon display section 541 for the areas, an area name 542 of the currently selected area, a distinguished range 543 for distinguishing the range of the game cards placed in the selected area, and a scroll bar 544 to scroll the game cards horizontally.

The viewing screen 540 in FIG. 43 is the one when the battle area is selected, thus “battle area” is displayed as the area name 542, and the game cards placed in the battle area of the player are displayed in the distinguished range 543. The game card presentation unit 66 presents partially overlapping game cards on a line, and displays the game cards in the distinguished range 543 in a large size to be distinguishable from the game cards placed in other areas.

When another icon in the icon display section 541 is selected with the viewing screen 540 displayed, the game card presentation unit 66 can also display, in the distinguished range 543, the game elements placed in the area of the selected icon. The example of FIG. 43 illustrates a case where “energy area” is selected in a state where “battle area” is selected. Furthermore, when the icon for the deck area is selected in a state where “energy area” is selected, a transition is made to the game cards placed in the deck area. However, since the deck area is an undisclosed area, the card images of the back surfaces are displayed, from which the character information of the placed game cards is invisible.

The game card presentation unit 66 displays moving game cards by moving the bar of the scroll bar 544. For example, the cards are scrolled to the right side by moving the scroll bar 544 to the left, and the cards are scrolled to the left side by moving the scroll bar 544 to the right. The game card presentation unit 66 shows the icon for an area according to a moving position, displays the game cards in the area in a large size within the distinguished range 543, and displays the other game cards in a small size. Note that the scroll bar 544 may be displayed only when the number of game cards needed to be presented exceeds a predetermined number, in other words, only when the number of game cards needed to be presented exceeds a number of cards which are undisplayable within the distinguished range 543.

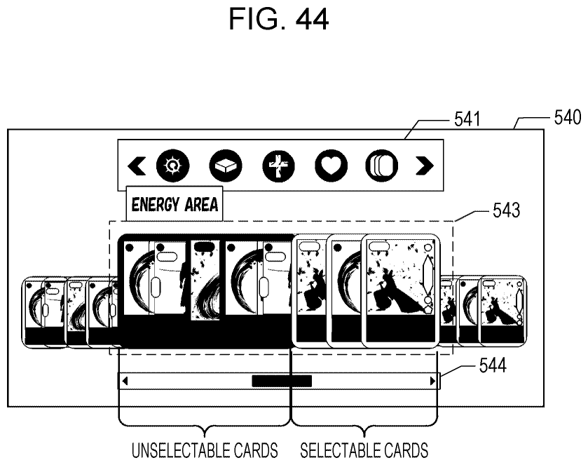

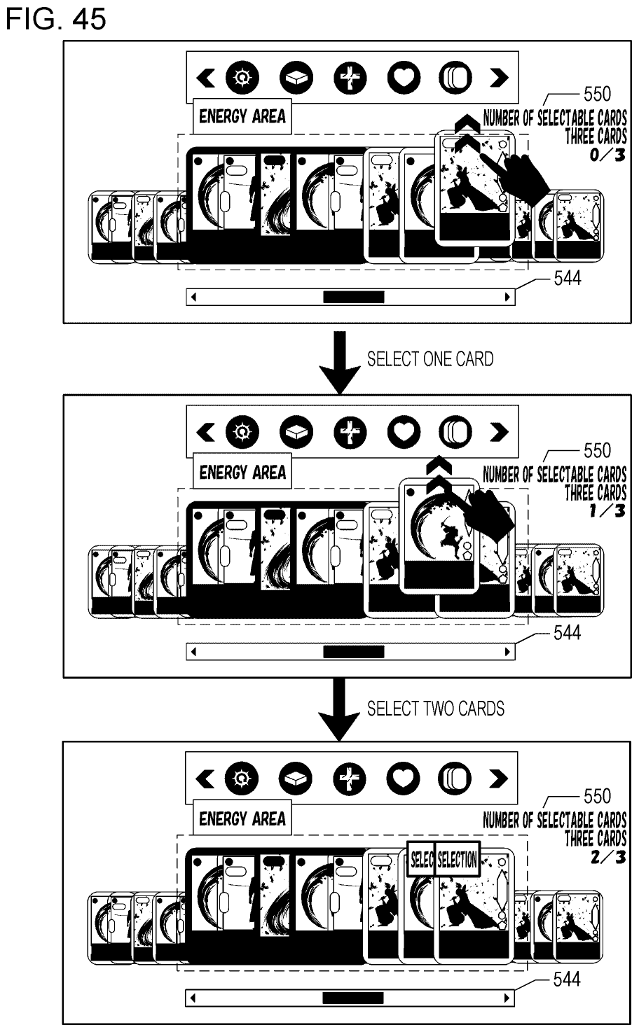

The viewing screen 540 can have not only the game card viewing function, but also a selection function of presenting the game cards in a state (actionable state) where placement to another area is allowed and ability can be exhibited, and the selectable number of game cards among the game cards displayed within the distinguished range 543. FIGS. 44 and 45 are views for explaining the selection function of the viewing screen 540. FIGS. 44 and 45 illustrate an example of the viewing screen 540 presented when the icon for energy area is selected. In the energy area, the game cards usable as energy and the game cards unusable as energy in a certain turn are present. In this situation, the game card presentation unit 66 displays the selectable game cards normally and the unselectable game cards in dark background. Thus, the player can easily identify the selectable game cards and the unselectable game cards.

In addition, the game card presentation unit 66 can display the number 550 of selectable cards in actionable game elements on the viewing screen 540. The example of FIG. 45 shows a case where the number of selectable cards is three. When the player selects one game card, the game card is moved above the other game cards and displayed to clarify that the game card has been selected. At this point, the selected game card is placed at the top of stacked cards so that the entire surface of the selected game card is displayed. When selection of the first game card is finished, the number of selected cards is incremented by one and displayed. When the second game card is further selected by the player, the game card is moved above the other game cards and displayed as in the selection of the first card. At this point, the selected game card is placed at the top of stacked cards so that the entire surface of the selected game card is displayed. When selection of the second game card is finished, the number of selected cards is incremented by one and displayed. Such display continues until the selectable number of cards is reached. Note that the appearance of the selected game card may be changed, for example, the boundary line may be highlighted to allow the selected game card to be easily distinguishable from the other game cards.

The game card presentation unit 66 has a function of displaying enlarged or reduced hand of cards. As illustrated in FIG. 41, the game card presentation unit 66 displays a hand of cards 560 of the player in the hand of cards area. In consideration of identifiability of the situation of the play field, the game card presentation unit 66 displays adjacently overlapping game cards in the hand of cards area in a small size in a row, and a lower portion of the displayed image is cut off. Consequently, it is possible to check the overall picture of the hand of cards while grasping the situation of the entire play field.

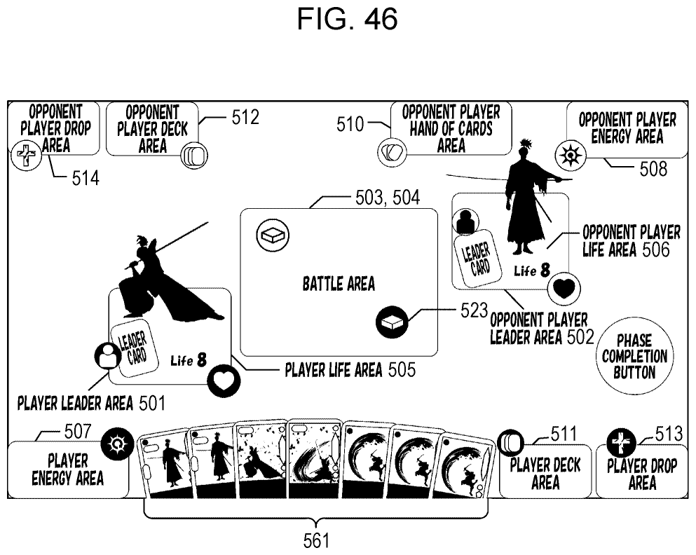

Upon an operation (for example, clicking or touching) to an area other than the area where the hand of cards 560 of the player is presented, the game card presentation unit 66 displays the hand of cards with magnification. FIG. 46 is a view illustrating an example when the hand of cards is enlarged. In the example of FIG. 46, a hand of cards 561 is displayed by arranging adjacently overlapping game cards in a fan shape in a row in a size larger than the hand of cards 560.

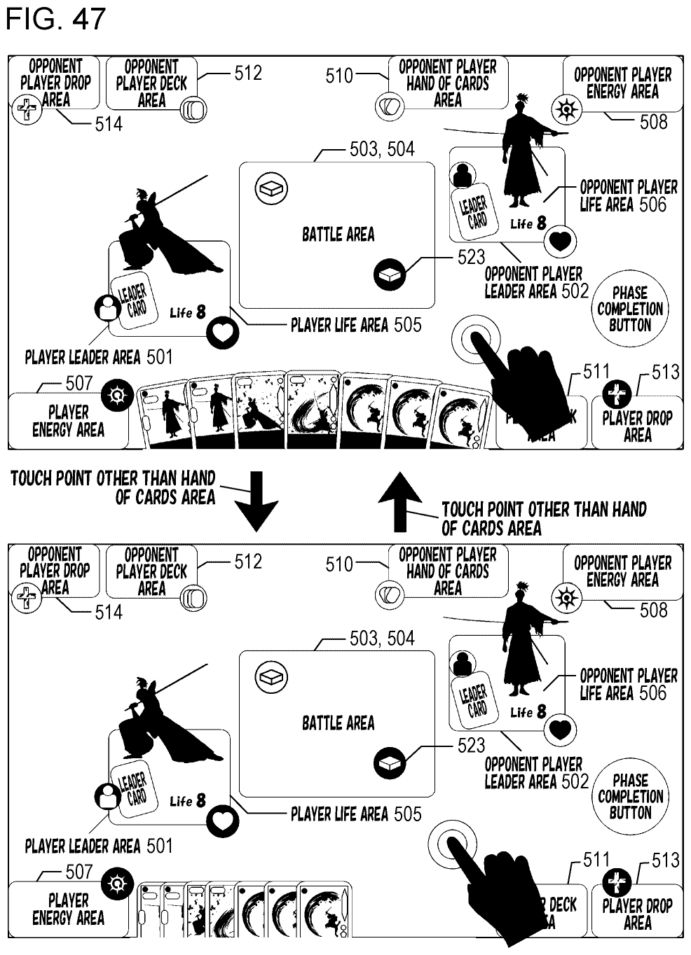

In addition, the game card presentation unit 66 has a function of switching between display of reduced hand of cards 560 and display of enlarged hand of cards 561. FIG. 47 shows views for explaining the switching between reduced display and enlarged display. A transition from the display of reduced hand of cards 560 to the display of enlarged hand of cards 561 can be made by an operation (for example, clicking or touching) to an area other than the area where the reduced hand of cards 560 is presented. A transition from the display of enlarged hand of cards 561 to the display of reduced hand of cards 560 can be made by an operation (for example, clicking or touching) to an area other than the area where the enlarged hand of cards 561 is presented. In this manner, switching between reduction and enlargement of display of the hand of cards is made.

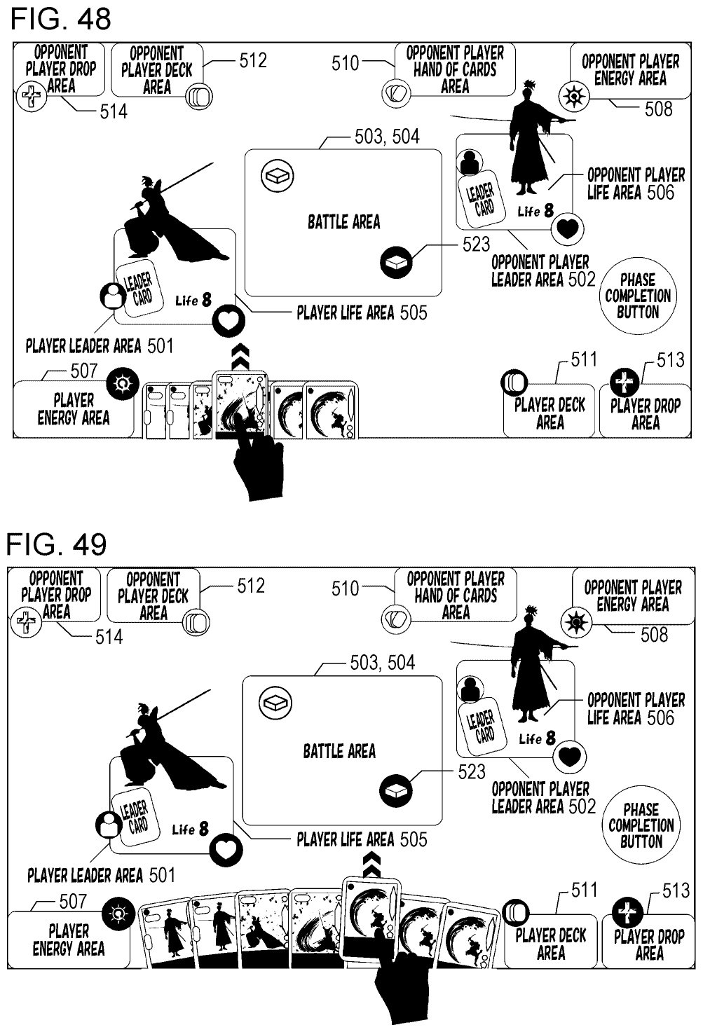

When the reduced hand of cards 560 and the enlarged hand of cards 561 are displayed, the game card presentation unit 66 displays the game cards in the hand of cards to allow selection from the game cards. When a game card is selected, as illustrated in FIGS. 48 and 49, to clarify the selected game card, the game card presentation unit 66 moves the game card above the other game cards to display the game card. At this point, the selected game card is placed at the top of stacked cards so that the entire surface of the selected game card is displayed. The appearance of the selected game card may be changed, for example, the boundary line may be highlighted to allow the selected game card to be easily distinguishable from the other game cards.

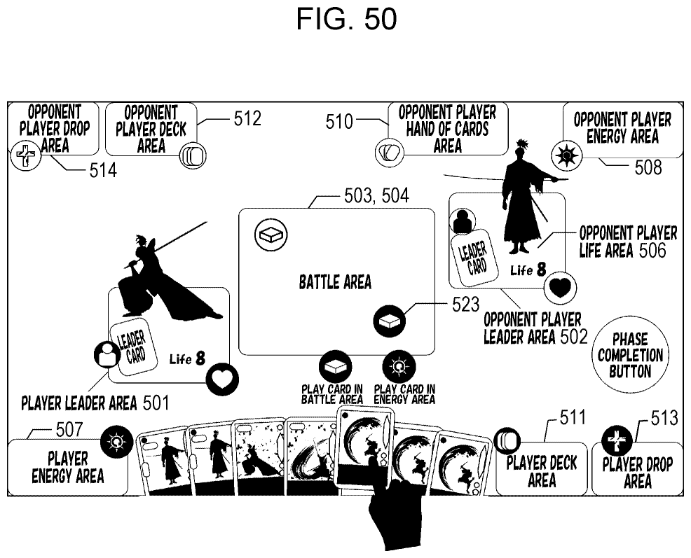

Furthermore, when a game card is selected with reduced hand of cards 560 or enlarged hand of cards 561 displayed, if the game card is in a state (actionable state) where placement to another area is allowed and ability can be exhibited, the game card presentation unit 66 has a function of displaying icons indicating the actions (selectable actions) which can be selected. FIG. 50 is a view illustrating an example of display of selectable actions. In the example of FIG. 50, two selectable actions “play card in battle area” and “play card in energy area” are presented as the selectable actions of the selected game card, and selecting the icon for a selectable action allows the selected game card to make a transition to the action.

### Configuration of Game Server 2

FIG. 19 is a block diagram illustrating a functional configuration example of the game server 2. The game server 2 includes a processor 70, a communicator 71, and a storage 72.

The processor 70 comprehensively controls the operation of the game server 2 based on the programs, data stored in the storage 72, and received information and the like. The function of the processor 70 can be implemented by e.g., a microprocessor such as a CPU or a GPU, and electronic parts such as an ASIC, an IC memory. The processor 70 has the functions of a player information manager 80, a game execution manager 81, a store manager 82, and a pack manager 83.

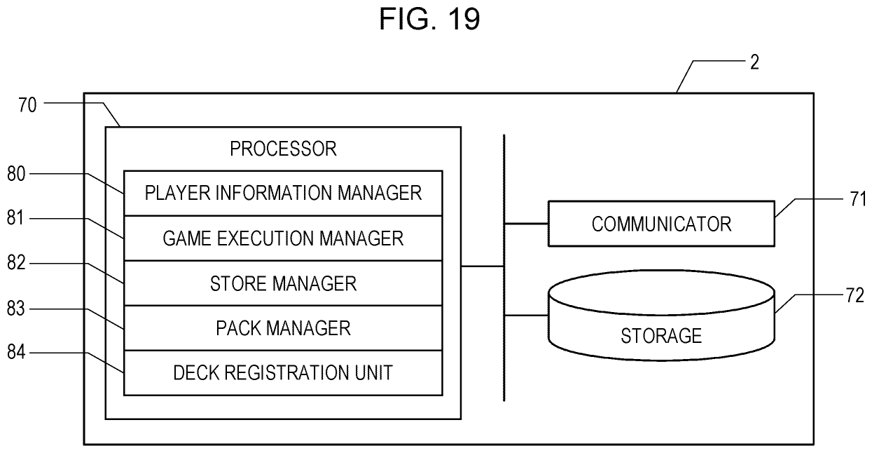

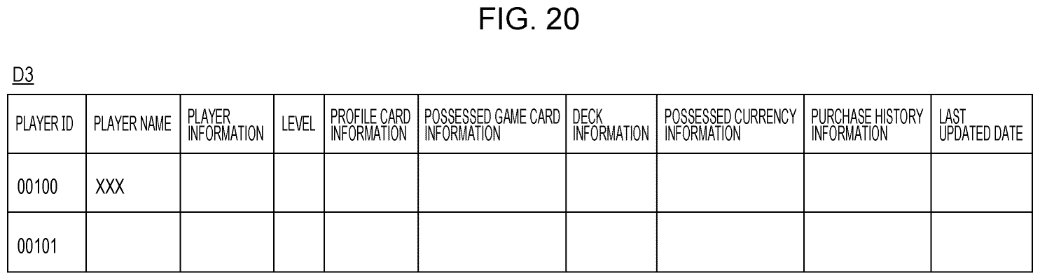

The player information manager 80 manages the information on players using the user information management database D3. FIG. 20 is a table illustrating an example of the user information management database D3. The user information management database D3 has one record for each player, and the record is similar to the user information database D1.

The player information manager 80 checks the player ID and the last updated date of the user information database D1 transmitted at the login to a game via the player terminal 1 with the player ID and the last updated date of the user information management database D3. When the last updated dates match, a notification of the match is transmitted, and when the last updated dates do not match, synchronization of the content of the user information database D1 is achieved between the player terminal 1 and the game server 2 by transmitting the information registered in the user information management database D3.

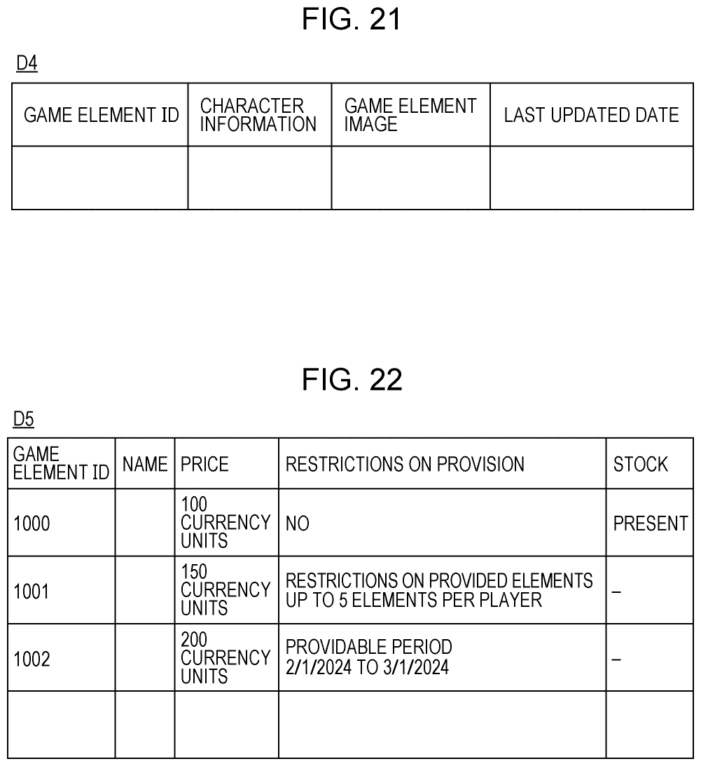

The game execution manager 81 grants and manages various parameters such as experience points based on matching between players, execution of a fighting game, and the result of the fighting game. The game execution manager 81 uses the game element management database D4 to manage various game elements such as the game cards used in games. FIG. 21 is a table illustrating an example of the game element management database D4. The game element management database D4 has information similar to the game element database D4 stored in each player terminal 1. The game execution manager 81 updates the game element database D4 due to appearance of a new game element. At the time of login via the player terminal 1, synchronization of the content of the game element database D2 is achieved between the player terminal 1 and the game server 2.

The store manager 82 manages a store that provides game elements using the store management database D5. FIG. 22 is a table illustrating an example of the store management database D5. In the example of FIG. 22, one record includes a field for game element ID to identify the game element to be provided, a field for the game element, a field for price (in-game currency) of the game element, a field for restrictions on the provision of the game element, and a field for stock of the game element.

In the field for game element ID, not only the game element ID of a game card or in-game currency itself is written, but also a game card pack (also including a deck) which is a set of multiple game cards, and identification information for an in-game currency pack which is a set of in-game currencies are written. Note that for a game card pack, the content of included game cards may be different even with the same identification information. In such a situation, a list of the game card IDs of the game cards (game cards which may be included in the game card pack) associated with the identification information for the game card pack is stored. At the time of provision to a player, the store manager 82 selects as many game card IDs as the number of cards in the game card pack from the list by drawing lots, and a set of the game cards with the selected game card IDs is provided as a game card pack. In the field for restrictions on provision, the content of restrictions on provision of the game element is written. As the restrictions on provision, for example, the number of times of provision (grant) of a game element, and a providable period are written. In the field for stock, when the number of times of provision are not restricted, “present” is written, and when the number of times of provision for all players are restricted, “the number of stocks” is written.

The store manager 82 receives a request from the player terminal 1, reads, from the store management database D5, the information on the game element to be provided, and transmits the information as store information.

The pack manager 83 uses a pack information database D10 to select a game element included in the purchased pack by drawing lots, and transmits pack information including the game ID of the selected game element to the player terminal 1.

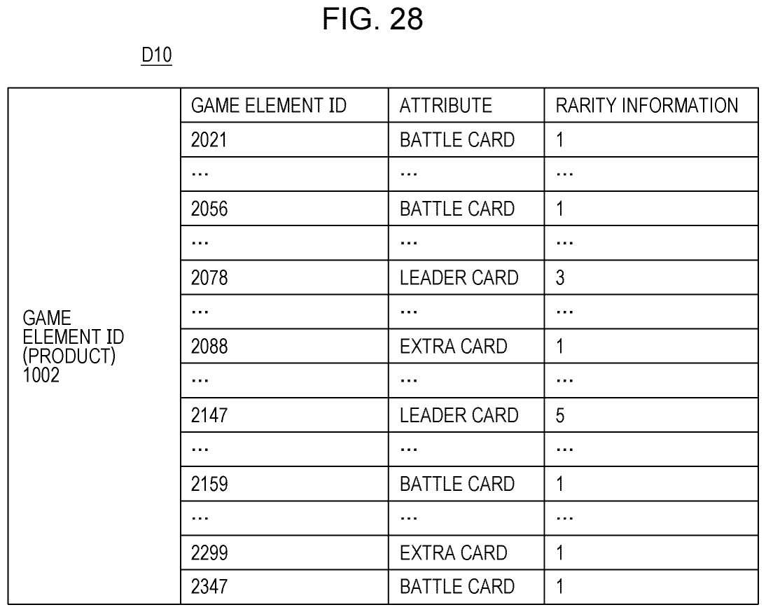

FIG. 28 is a table illustrating an example of the pack information database D10. For each game element ID to identify the pack, a field for game element ID to identify the game elements which may be included in the pack, a field for attribute, and a field for rarity information are provided. The field for attribute is for recording the attribute of a game card such as a leader card. The field for rarity information is for recording rarity information of a game card on a scale of 1 to 5. The number of game element IDs of the game cards with the game element ID of one pack, included in the pack information database D10 is at least greater than or equal to the number of game cards included in the one pack. A game card with the game element ID of one pack included in the pack information database D10 for is less common when the game card is with higher value information, and is more common when the game card is with lower value information. Thus, when a game card is selected at random, a game card with higher value information has a lower probability of being selected, and a game card with lower value information has a higher probability of being selected.

From the pack information database D10 for the game element ID of the pack purchased by a player, the pack manager 83 randomly selects as many game element IDs as the number of game cards included in the pack by drawing lots. In the present embodiment, the number of game cards included in the pack is eight, thus the pack manager 83 selects eight game element IDs by drawing lots from the pack information database D10. The pack manager 83 then generates pack information including the game element ID of the purchased pack, and the game element IDs of the game elements selected by drawing lots, and transmits the pack information to the player terminal 1. A deck registration unit 84 receives the content of the deck information database D20 transmitted from the deck former 64 of the player terminal 1, and updates the deck information database D20 stored in the storage 72 with the updated date. Note that the deck information database D20 is similar to the deck information database D20 of the player terminal 1.

The communicator 71 connects to the communication line N to establish communication.

The storage 72 stores a system program and a game program. The system program implements the basic functions of the game server 2 as a computer. The game program causes the processor 70 to function as the player information manager 80, the game execution manager 81, the store manager 82, the pack manager 83, and the deck registration unit 84.

In addition, a recorder 72 stores the user information management database D3, the game element management database D4, the store management database D5, and the deck information database D20.

### Operation of Each Device

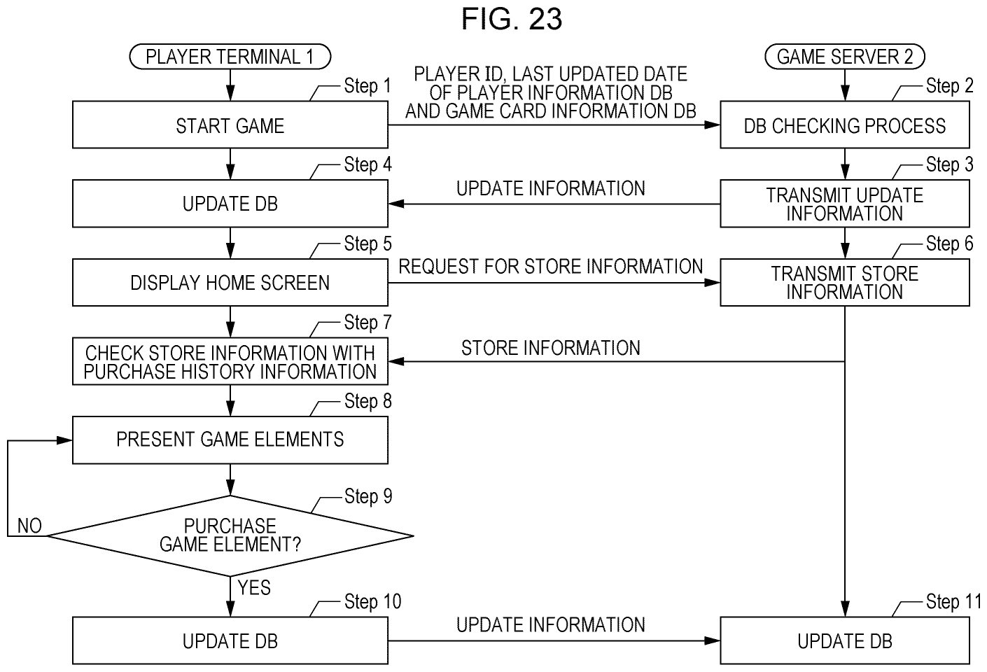

The operation of the player terminal 1 and the game server 2 will be described. FIG. 23 is a sequence diagram for explaining the operation of the player terminal 1 and the game server 2. In the following, a description will be given assuming that a player has completed the initial setting for the game, and a player ID has been granted to the player.

When a player starts a game application of the player terminal 1, the game execution controller 61 transmits the player ID of the player, and the last updated date of the player information database D1 and the game element database D2 to the game server 2 (Step 1).

The player information manager 80 of the game server 2 checks the last updated date of the received player ID with the last updated date of the player ID of the player information management database D3 (Step 2). When the last updated dates match, the player information manager 80 transmits a notification of the match. In contrast, when the last updated dates do not match, the player information manager 80 transmits each information stored in the record of the player ID of the player information management database D3 (Step 3). Thus, player information is synchronized between the player terminal 1 and the game server 2. Similarly, the player information manager 80 checks the last updated date of the game element database D2 with the last updated date of the game element management database D4, and when the last updated dates do not match, transmits each information of the game element management database D4. Thus, game element information is synchronized between the player terminal 1 and the game server 2. Note that the information transmitted from the game server 2 may be information on the difference between the player terminal 1 and the game server 2.

The player information manager 60 and the game execution controller 61 of the player terminal 1 receive notification of database from the game server 2, and update the player information database D1 and the game element information database D2 as necessary (Step 4).

The store presentation controller 62 of the player terminal 1 displays the home screen illustrated in FIG. 11, and requests the game server 2 for store information (Step 5).

The store manager 82 of the game server 2 receives the request from the player terminal 1, reads, from the store management database D5, each information of the game element to be provided, and transmits the information as the store information (Step 6).

The store presentation controller 62 of the player terminal 1 receives the store information. For a game element with restrictions on provision among the game elements of the store information, the store presentation controller 62 checks the restrictions on provision with the purchase history information of the player information database D1, and determines whether the game element is providable (grantable) or unprovidable (ungrantable) (Step 7). When the store tab 202 is selected, the store presentation controller 62 presents providable (grantable) game elements, and unprovidable (ungrantable) game elements in a distinguishable format, presents providable (grantable) game elements as selectable, and presents unprovidable (ungrantable) game elements as unselectable (Step 8).

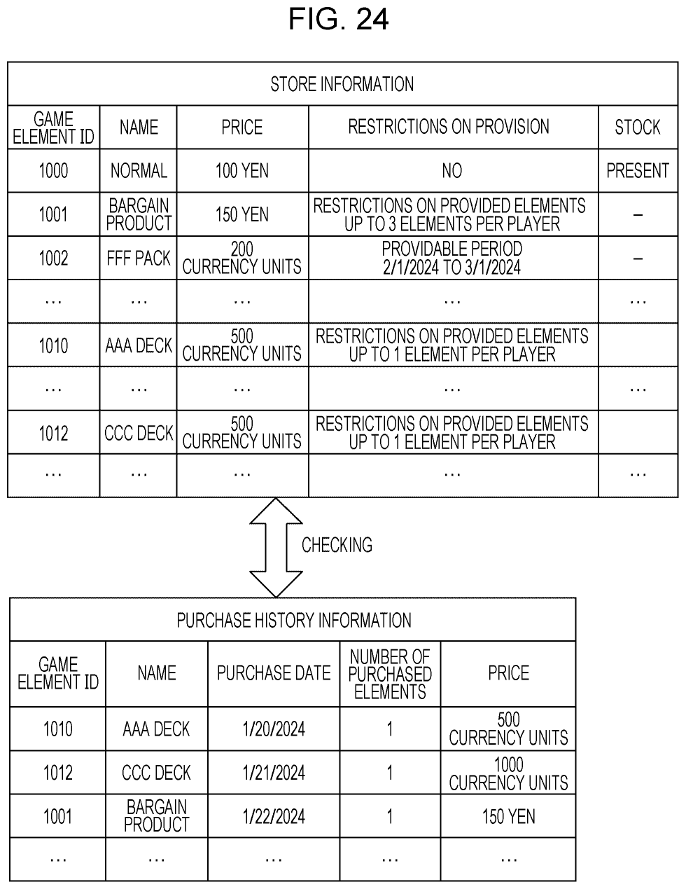

FIG. 24 shows tables for explaining determination as to whether each game element is providable (grantable) or unprovidable (ungrantable). FIG. 24 illustrates the received store information, and the purchase history information of the player information database D1. The store presentation controller 62 determines whether a game element ID with restrictions on provision in the received store information has been registered in the purchase history information. In the example of FIG. 24, “bargain product” with a game element ID “1001”, “FFF pack” with a game element ID “1002”, . . . , “AAA deck” with a game element ID “1010”, . . . , and “CCC deck” with a game element ID “1012” have restrictions on provision. In contrast, in the purchase history information, “AAA deck” with a game element ID “1010”, “CCC deck” with a game element ID “1012”, and “bargain product” with a game element ID “1001” have one-time purchase history.

On the screen for the starter deck on the store screen, as illustrated in FIG. 14, the store presentation controller 62 presents the area 220 for “AAA deck” and “CCC deck” in a sold-out state expressed in black, which is distinguishable from the area 221 for “BBB deck” and “DDD deck” in a providable state, and changes the display of the option 211 for “AAA deck” and “CCC deck” to “SOLD OUT” indicating a sold-out state, thereby presenting the option 211 as unselectable by the player.

The “bargain product” with a game element ID “1001” has been purchased once, and the upper limit of restricted number of times of purchase has not been reached. Therefore, when the in-game currency providing screen transition button 209 to make a transition to the in-game currency providing screen is selected on any screen, as illustrated in FIG. 16, the store presentation controller 62 presents the paid-for currency pack 231 as the “bargain product” and the paid-for currency pack 232 on the in-game currency providing screen.

The store presentation controller 62 grants a game element to the player through selection of the game element, and exchange the game element with a price or in-game currency by the player (Step 9). In this trading, the store presentation controller 62 refers to the possessed currency information of the player information database D1, and consumes the possessed currency in the following order.
1. The free of charge currency is consumed in ascending order of the date of acquisition.
2. After the free of charge currency units reaches zero, the paid-for currency is consumed in ascending order of the date of acquisition.

The store presentation controller 62 then updates the possessed game card information, the possessed currency information, or the purchase history information of the player information database D1, and transmits the updated information of the player information database D1 to the game server 2 (Step 10).

The player information manager 80 of the game server 2 receives the updated information of the player information database D1, and updates the player information on the player (Step 11). The above operation is repeated for each selection, and purchase by the player.

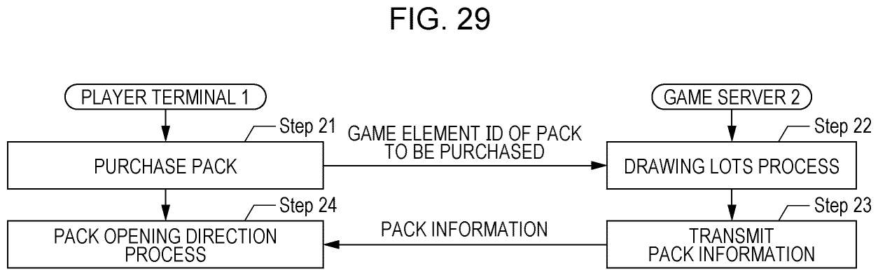

Next, the operation of the player terminal 1 and the game server 2 at the time of purchase of a pack will be described. FIG. 29 is a sequence diagram for explaining the operation of the player terminal 1 and the game server 2.

The player of the player terminal 1 selects a desired pack from the store screen, and the player terminal 1 transmits the game element ID of the selected pack (Step 21).

After completion of the purchase procedure of the pack, the game server 2 performs a drawing lots process on the game elements to be included in the pack (Step 22). The game server 2 then transmits the pack information on the pack (Step 23). In the present embodiment, it is assumed that the pack consists of eight game cards, and the following game element IDs are selected by drawing lots: a game element ID “2021”, a game element ID “2056”, a game element ID “2078”, a game element ID “2088”, a game element ID “2147”, a game element ID “2159”, a game element ID “2299”, and a game element ID “2347”.

The player terminal 1 receives the pack information, and starts a pack opening direction process (Step 24).

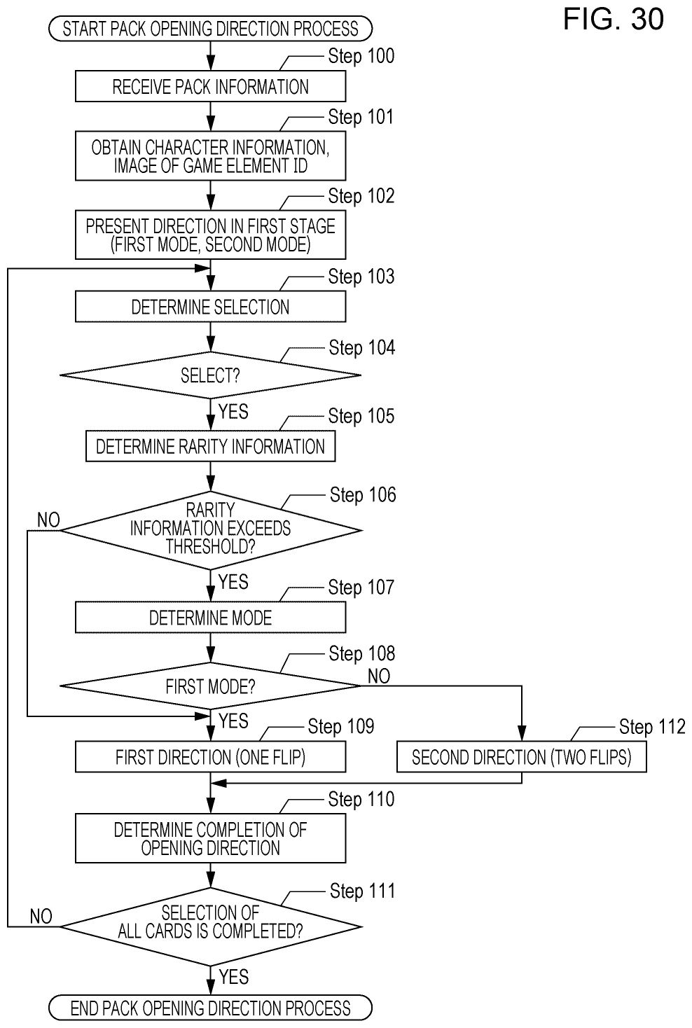

Next, the pack opening direction process performed at the player terminal 1 will be described. FIG. 30 is a flowchart for the pack opening direction process.

The direction presentation controller 63 receives the pack information on the pack provided from the game server 2 (Step 100). The game element IDs of the eight game cards included in the received pack information are assumed to be the game element ID “2021”, the game element ID “2056”, the game element ID “2078”, the game element ID “2088”, the game element ID “2147”, the game element ID “2159”, the game element ID “2299”, and the game element ID “2347”.

The direction presentation controller 63 obtains rarity information corresponding to the game element IDs from the game element information database D2. The pieces of rarity information corresponding to the game element IDs are as follows (Step 101):

The rarity information for the game element ID “2021” is “1”.

The rarity information for the game element ID “2056” is “1”.

The rarity information for the game element ID “2078” is “3”.

The rarity information for the game element ID “2088” is “1”.

The rarity information for the game element ID “2147” is “5”.

The rarity information for the game element ID “2159” is “1”.

The rarity information for the game element ID “2299” is “1”.

The rarity information for the game element ID “2347” is “1”.

The direction presentation controller 63 directs and presents the game cards in the first mode and the second mode as the direction in the first stage (Step 102). In this example, the threshold value for rarity information is assumed to be “2”.

As illustrated in FIG. 27A, as the direction in the first stage, the direction presentation controller 63 indicates that the game card 303 has high rarity information in the first mode in which the outer edge of the back surface of the game card 303 is thickened. In contrast, other game cards excluding the game card 303 are presented in the second mode.

The direction presentation controller 63 determines selection of a game card (Step 103). When a game card is selected (Step 104), the rarity information of the game card is determined (Step 105). When the rarity information of the selected game card exceeds a threshold value (Step 106), the mode of the game card is determined (Step 107).

When the mode of the selected game card is the first mode (Step 108), as illustrated in FIG. 27B, the direction presentation controller 63 performs the first direction (one flip) (Step 109). In contrast, when the mode of the selected game card is not the first mode (Step 108), as illustrated in FIG. 27E, the direction presentation controller 63 performs the second direction (two flips) (Step 112).

The direction presentation controller 63 determines whether all presented game cards have been selected (determines completion of the opening direction process) (Step 110), and upon completion of the selection of all game cards, ends the opening direction process (Step 111).

In the embodiment of the present invention, in addition to the game elements that are sold normally, the game elements that are provided (granted) only in a specific number or in a specific time period are supplied, thus the interest of each player to the game elements can be maintained continually.

In the embodiment of the present invention, currently untradable game elements are presented as unselectable so that the player can recognize the game elements provided in the past, and the interest of the player to the game elements can be maintained continually. In addition, the player cannot select from the unprovidable game elements presented, thus such a game element cannot be selected by mistake, and the convenience of the player is improved.

In the present embodiment, each screen is provided with means (for example, an icon, a button) for making a transition to the in-game currency providing screen, thus it is possible to make a transition from each screen to the in-game currency providing screen to obtain in-game currency as necessary, and the convenience of the player is improved.

In the present embodiment, each screen is provided with means (for example, an icon, a button) for showing the breakdown of the in-game currency, thus the player can recognize the balance of possessed in-game currency, and the breakdown between paid-for and free of charge in-game currency as necessary, and the convenience of the player is improved.

In the present embodiment, as a method for directing opening the game cards, a first direction method performed when value information does not exceed a threshold value, a second direction method performed when value information exceeds a threshold value, and a third direction method performed on a special game card when value information exceeds a threshold value are combined to direct the opening of the game cards, thereby making it possible to provide games that are unexpected to the player and have enhanced enjoyment.

In the present embodiment, the first area for displaying the leader card included in a deck, and the second area for displaying the other game cards included in the deck are presented, and only one leader card is displayed in the first area, thus the leader card required to form a deck can be emphasized.

In the second area, multiple same game cards included in a deck are displayed in a stacked form, thus the player can easily recognize that there are multiple same game cards.

A list of the game cards forming a deck can be displayed, and a function of enlarged display to know the details of the game cards is provided, thus the convenience of the player is improved.

In addition, when a deck is registered, it is determined whether any non-conforming condition for deck is satisfied, thus a deck unusable for a fighting game is not registered as a usable deck for a fighting game by mistake.

In the present embodiment, the viewing function for the player to easily view the game cards placed in each area of the play field, and the hand of cards enlargement/reduction function, and selection function are provided, thus a highly convenient environment for playing by the player can be provided.

### Modification 1 of Embodiment

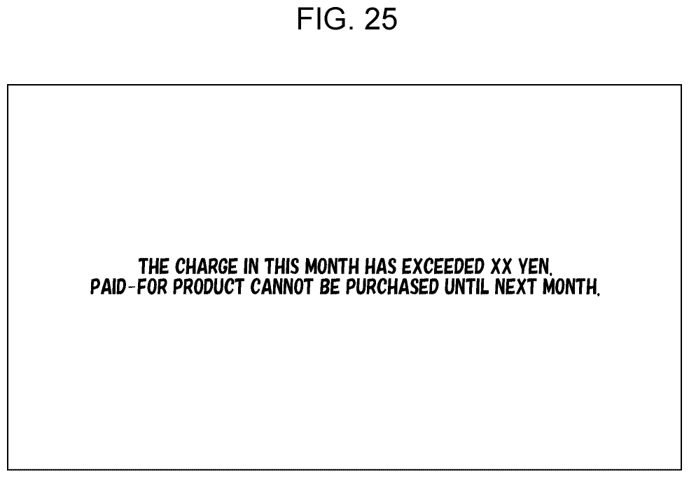

The store presentation controller 62 may set an upper limit amount to be charged daily, monthly, or yearly, and when the total charge exceeds the upper limit amount in trading of a game element, which involves charging, may notify of the situation. For example, the store presentation controller 62 may calculate a monthly total charge from the purchase history information of the player information database D1, and when the total charge exceeds a predetermined amount, may notify of the situation in trading of game elements. FIG. 25 is a view illustrating an example of a notification made when the total charge exceeds a predetermined amount. With this configuration, excessive charging can be avoided, and particularly, people who do not have a solid financial base, such as minors can be protected.

### Modification 2 of Embodiment

The store presentation controller 62 may set an upper limit to the possessable amount of in-game currency. For example, when the player purchases new in-game currency on the in-game currency providing screen, the store presentation controller 62 refers to the possessed currency information of the player information database D1, and when purchase of the new in-game currency causes the possessed currency units (the total of the paid-for currency units and the free of charge currency units) to exceed a predetermined amount, presents a selection button for in-game currency in a distinguishable manner from the other selection buttons. When the selection button is selected, the store presentation controller 62 notifies that the upper limit of possessable in-game currency is exceeded, and prohibits the purchase of the new in-game currency.

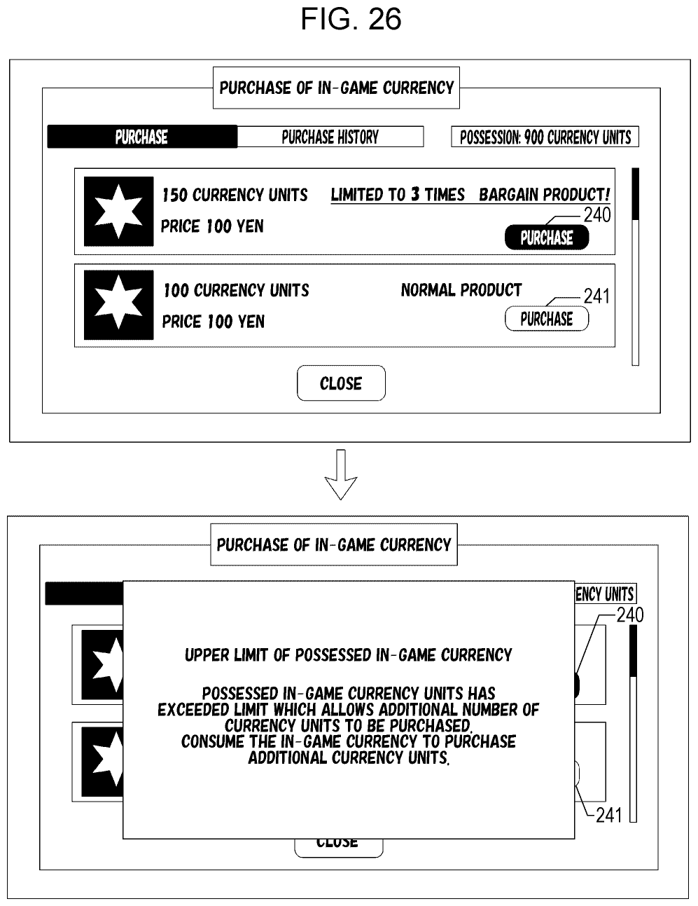

FIG. 26 shows views for explaining modification 2 of the embodiment. In the example of FIG. 26, the upper limit of possessed currency is set to 1000. When the bargain product is purchased, the total of possessed in-game currency units is 1050 which exceeds the upper limit 1000, but when a normal product is purchased, the total is 1000 which does not exceed the upper limit 1000. Thus, a button 240 to select the bargain product is presented as unselectable in black, and a button 241 to select the normal product is presented as selectable in white. Thus, the player cannot select the bargain product. In addition, when the player selects the button 240, the following message is displayed: “the possessed in-game currency has exceeded additionally purchasable currency units. Consume in-game currency to purchase new product.

With this configuration, in-game currency more than necessary does not need to be possessed, excessive charging can be avoided, and particularly, people who do not have a solid financial base, such as minors can be protected.

### Modification 3 of Embodiment

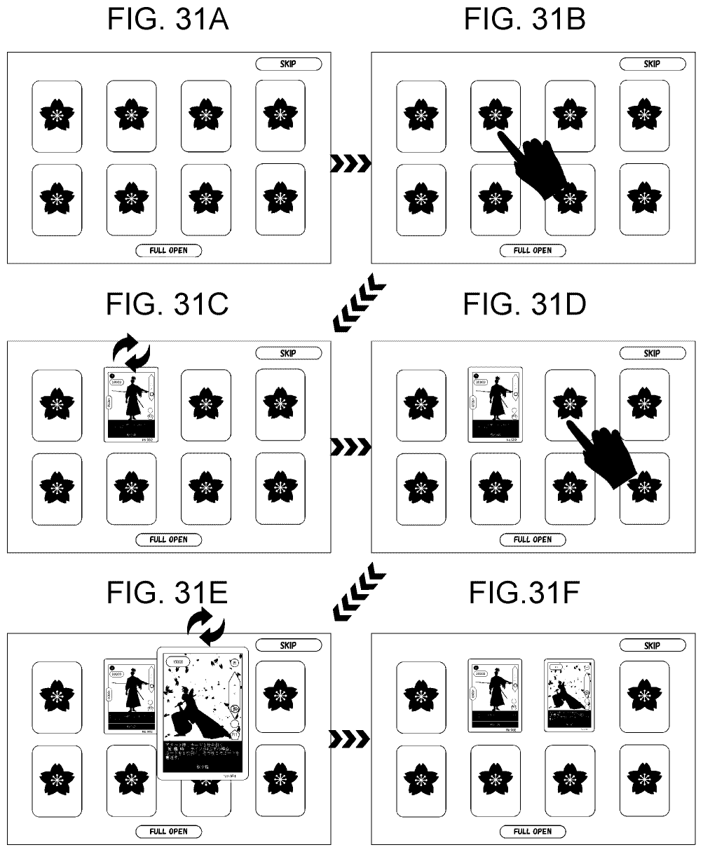

Modification 3 of the present embodiment will be described. Modification 3 of the present embodiment is another example of the above-described pack opening direction. FIGS. 31A to 31F show views for explaining an opening direction example.

According to the pack opening direction method in modification 3 of the present embodiment, in the first stage, all game cards are presented with the same size and picture pattern (back surfaces) regardless of value information. When the value information of the selected game card does not exceed a predetermined threshold value, the first direction (one flip) is performed in which the game card is turned back to front, the front surface of game card 2 is displayed, and the character information is recognizably presented (FIG. 31C). In contrast, when the value information of the selected game card exceeds a predetermined threshold value, the game card is displayed in an enlarged scale, and the character information is recognizably presented (FIG. 31E). Subsequently, the game card is resumed to normal display (FIG. 31F). By adopting such direction method, the opening direction for the pack can be performed according to the value information.

### Modification 4 of Embodiment

Modification 4 of the present embodiment will be described. Modification 4 of the present embodiment is another example of the above-described pack opening direction. FIGS. 31A to 31F show views for explaining an opening direction example.

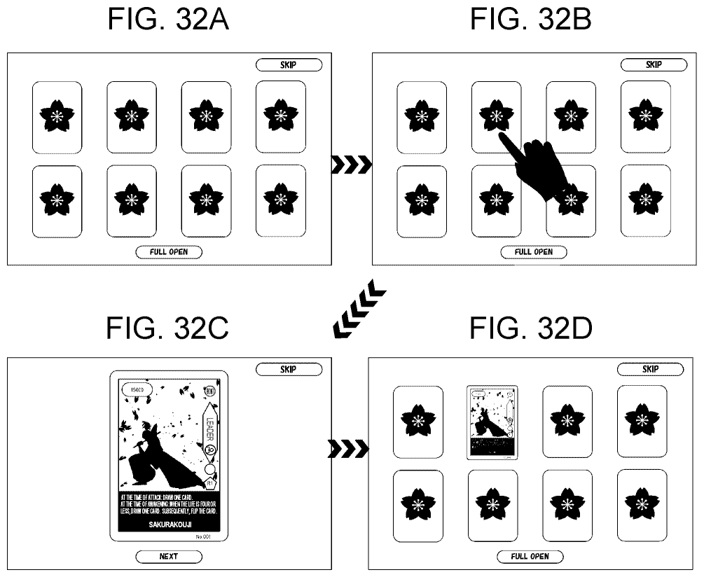

According to the direction method in modification 4 of the present embodiment, in the first stage, all game cards are presented with the same size and picture pattern (back surfaces) regardless of value information (FIG. 32A). The direction method is such that each time a card is selected, only the selected game card is displayed in an enlarged scale (FIG. 31C). The direction method in modification 4 of the present embodiment is advantageous in that character information is easily visually recognized because the game cards are displayed in an enlarged scale one by one.

Although the present invention has been described by way of a preferred embodiment above, the present invention is not necessarily limited to the aforementioned embodiment, and various modifications may be made within the scope of the technical idea.

Part or all of the aforementioned embodiment is described as in the appendix below, but is not limited thereto.

### Appendix 1

A program causing a computer to function as:
an execution unit configured to execute a fighting game using a game element;
a play field presentation unit configured to present a play field including a plurality of areas; and
a game element presentation unit configured to present character information of a game element of a player positioned in a first area among the plurality of areas so that the character information is visually unrecognizable to an opponent player, and to present character information of a game element of the player positioned in a second area so that the character information is visually recognizable to the opponent player.

### Appendix 2

The program according to Appendix 1,
wherein the game element presentation unit is configured to present the character information of the game element of the player positioned in at least part of the first area so that the character information is visually recognizable to the player.

### Appendix 3

The program according to Appendix 1 or 2,
wherein the play field presentation unit is configured not to present a boundary line between the first area and the second area in a visually recognizable manner.

### Appendix 4

The program according to any one of Appendices 1 to 3,
wherein the first area is greater in number than the second area.

### Appendix 5

The program according to any one of Appendices 1 to 4,
wherein the game element presentation unit is configured to position a game element in one of the first area or the second area according to a type of the game element.

### Appendix 6

The program according to any one of Appendices 1 to 5,
wherein the fighting game includes a plurality of turns, and
the game element presentation unit is configured to perform control to allow the game element to be positioned in at least one of the first area or the second area in each of the turns of the player.

### Appendix 7

The program according to any one of Appendices 1 to 6, wherein the game element presentation unit is configured to control the game element positioned in the first area movably to the second area according to a progress of the fighting game.

### Appendix 8

The program according to any one of Appendices 1 to 7, wherein the game element includes a first type game element, and a second type game element, and the game element presentation unit is configured to position the first type game element in one area in the second area, and to position the second type game element in the first area and the second area other than the one area.

### Appendix 9

The program according to any one of Appendices 1 to 8, wherein the game element presentation unit is configured to present the first type game element as a human-like image, and to present the second type game element as a card-like image.

### Appendix 10

The program according to any one of Appendices 1 to 9, wherein the game element presentation unit is configured to control the first type game element immovably from the one area in the second area to another area.

### Appendix 11

A gaming device comprising: an execution unit configured to execute a fighting game using a game element; a play field presentation unit configured to present a play field including a plurality of areas; and a game element presentation unit configured to present character information of a game element of a player positioned in a first area among the plurality of areas so that the character information is visually unrecognizable to an opponent player, and to present character information of a game element of the player positioned in a second area so that the character information is visually recognizable to the opponent player.

What is claimed is:

1. A non-transitory computer readable medium storing a program causing a computer to function as:
an execution unit configured to execute a fighting game using a game element;
a play field presentation unit configured to present a play field including a plurality of areas; and
a game element presentation unit configured to present character information of a game element of a player positioned in a first area among the plurality of areas so that the character information is visually unrecognizable to an opponent player, and to present character information of a game element of the player positioned in a second area so that the character information is visually recognizable to the opponent player.

2. The non-transitory computer readable medium according to claim 1, wherein the game element presentation unit is configured to present the character information of the game element of the player positioned in at least part of the first area so that the character information is visually recognizable to the player.

3. The non-transitory computer readable medium according to claim 1, wherein the play field presentation unit is configured not to present a boundary line between the first area and the second area in a visually recognizable manner.

4. The non-transitory computer readable medium according to claim 3, wherein the first area is greater in number than the second area.

5. The non-transitory computer readable medium according to claim 3, wherein the game element presentation unit is configured to position a game element in one of the first area or the second area according to a type of the game element.

6. The non-transitory computer readable medium according to claim 5, wherein the fighting game includes a plurality of turns, and
the game element presentation unit is configured to perform control to allow the game element to be positioned in at least one of the first area or the second area in each of the turns of the player.

7. The non-transitory computer readable medium according to claim 5, wherein the game element presentation unit is configured to control the game element positioned in the first area movably to the second area according to a progress of the fighting game.

8. The non-transitory computer readable medium according to claim 5, wherein the game element includes a first type game element, and a second type game element, and
the game element presentation unit is configured to position the first type game element in one area in the second area, and to position the second type game element in the first area and the second area other than the one area.

9. The non-transitory computer readable medium according to claim 8, wherein the game element presentation unit is configured to present the first type game element as a human-like image, and to present the second type game element as a card-like image.

10. The non-transitory computer readable medium according to claim 9, wherein the game element presentation unit is configured to control the first type game element immovably from the one area in the second area to another area.

11. A gaming device comprising:
an execution unit configured to execute a fighting game using a game element;
a play field presentation unit configured to present a play field including a plurality of areas; and
a game element presentation unit configured to present character information of a game element of a player positioned in a first area among the plurality of areas so that the character information is visually unrecognizable to an opponent player, and to present character information of a game element of the player positioned in a second area so that the character information is visually recognizable to the opponent player.

12. The non-transitory computer readable medium according to claim 2, wherein the play field presentation unit is configured not to present a boundary line between the first area and the second area in a visually recognizable manner.
